(19) United States
(12) Patent Application Publication
(10) Pub. No.: US 2025/0190459 A1
(43) Pub. Date: Jun. 12, 2025

(54) SYSTEMS AND METHODS FOR DEVELOPMENT, ASSESSMENT, AND/OR MONITORING OF A GENERATIVE AI SYSTEM

(71) Applicant: DataRobot, Inc., Boston, MA (US)

(72) Inventors: Alexander Jason Conway, Boston, MA (US); Stefan Hackman, Schliersee (DE); Michael Schmidt, Washington, DC (US); Debanjan Saha, Los Altos, CA (US); Jay Schuren, Lunenberg, MA (US); Mark L. Steadman, Watertown, MA (US); Venkatesh Veeraraghavan, Seattle, WA (US); Mikalai Valynets, Munich (DE); Achraf Hamrit, Dubai (AE); Jillian Schwiep, San Francisco, MA (US); Marcus Braun, Minneapolis, MN (US); Asli Sabanci Demiroz, Campbell, CA (US); Mykola Novik, Melrose, MA (US); Brian Bell, Copenhagen (DK); Marshall Krassenstein, Pittsburgh, PA (US)

(73) Assignee: DataRobot, Inc., Boston, MA (US)

(21) Appl. No.: 18/801,663

(22) Filed: Aug. 12, 2024

Related U.S. Application Data
(60) Provisional application No. 63/518,853, filed on Aug. 10, 2023.
(60) Provisional application No. 63/518,856, filed on Aug. 10, 2023.
(60) Provisional application No. 63/518,875, filed on Aug. 10, 2023.
(60) Provisional application No. 63/638,937, filed on Apr. 25, 2024.

(51) Int. Cl. G06F 16/3329; G06N 5/022

(52) U.S. Cl. CPC G06F 16/3329; G06N 5/022

(57) ABSTRACT

A method for developing a generative AI system may include constructing a plurality of generative AI systems, wherein constructing the generative AI systems includes executing at least one modeling blueprint; providing a plurality of queries to each of the generative AI systems, the queries being part of an evaluation dataset; during processing of the queries by each generative AI system, monitoring values of one or more quantitative metrics; providing, for display by a user device, data indicating the values of the quantitative metrics for each generative AI system; and providing, for display by the user device, a recommendation regarding use or non-use of at least one generative AI system included in the plurality of generative AI systems.

### CROSS-REFERENCE TO RELATED APPLICATIONS

This application claims the benefit under 35 U.S.C. § 119(e) of U.S. Provisional Application Ser. No. 63/518,853, titled “Systems and Methods for Development, Design, and Assessment of Knowledge Base and Large Language Model (LLM)” and filed on Aug. 10, 2023 (Ref. No. DRB-400-PR), and claims the benefit under 35 U.S.C. § 119(e) of U.S. Provisional Application Ser. No. 63/518,856, titled “Systems and Methods for Automated Quantitative Assessment of Large Language Models, and Applications Thereof” and filed on Aug. 10, 2023 (Ref. No. DRB-401-PR), and claims the benefit under 35 U.S.C. § 119(e) of U.S. Provisional Application Ser. No. 63/518,875, titled “Systems and Methods for Deploying and Monitoring an AI Application with Generative and Predictive Models” and filed on Aug. 10, 2023 (Ref. No. DRB-402-PR), and claims the benefit under 35 U.S.C. § 119(e) of U.S. Provisional Application Ser. No. 63/638,937, titled “Systems and Methods for Developing and Deploying an AI Application with Generative and Predictive Models” and filed on Apr. 25, 2024 (Ref. No. DRB-402-PR2), each of which is hereby incorporated by reference herein in its entirety.

### BACKGROUND

The present disclosure generally relates to generative artificial intelligence (“generative AI” or “Gen AI”) and automated machine learning (“Auto ML”). Portions of the disclosure relate specifically to systems and methods for the development, assessment, and/or monitoring of a generative AI system.

“Automated machine learning” technology may be used to automate significant portions of the process of developing machine learning (“ML”) tools and artificial intelligence (“AI”) systems.

Recently, generative artificial intelligence systems have been developed. Generative AI technology has the ability to generate new and original content, including text, imagery, audio, source code, synthetic data, etc. Generative AI, driven by AI algorithms and advanced neural networks, empowers machines to go beyond traditional rule-based programming and engage in autonomous, creative decision-making. By leveraging vast amounts of data and the power of machine learning, generative models can generate new content, simulate human-like behavior, and even compose music, write code, and create visual art. This technology is quickly impacting diverse industries and sectors, from healthcare and finance to manufacturing and entertainment.

### SUMMARY

In some aspects, the techniques described herein relate to a generative AI system development method, the method including: constructing, by one or more processors, a plurality of generative AI systems, wherein constructing the plurality of generative AI systems includes executing at least one modeling blueprint; providing, by the one or more processors, a plurality of queries to each generative AI system in the plurality of generative AI systems, the plurality of queries being part of an evaluation dataset; during processing of the plurality of queries by each generative AI system, monitoring values of one or more quantitative metrics; providing, by the one or more processors for display by a user device, data indicating the values of the one or more quantitative metrics for each generative AI system; and providing, by the one or more processors for display by the user device, a recommendation regarding use or non-use of at least one generative AI system included in the plurality of generative AI systems.

In some aspects, the techniques described herein relate to a method, wherein each generative AI system in the plurality of generative AI systems is configured to operate as a chat bot, a natural language interface to a knowledge base, or content generation engine.

In some aspects, the techniques described herein relate to a method, wherein each generative AI system in the plurality of generative AI systems is a retrieval-augmented generation (RAG)-based generative AI system.

In some aspects, the techniques described herein relate to a method, wherein each generative AI system in the plurality of generative AI systems includes a knowledge base, a prompt construction facility, and a generative model.

In some aspects, the techniques described herein relate to a method, wherein the constructing of each generative AI system in the plurality of generative AI systems is performed based on a set of values of a set of hyperparameters, and wherein the respective set of hyperparameter values corresponding to each generative AI system determines one or more attributes of the knowledge base, the prompt construction facility, or the generative model included in the generative AI system.

In some aspects, the techniques described herein relate to a method, wherein the one or more attributes of the knowledge base include a type of encoder used to create a plurality of embeddings of the knowledge base, the plurality of embeddings representing a plurality of portions of source data.

In some aspects, the techniques described herein relate to a method, wherein the one or more attributes of the prompt construction facility include (i) a process by which the prompt construction facility identifies one or more embeddings in the knowledge base matching an embedding representing a query, (ii) a process by which source data corresponding to the identified one or more embeddings is added to a constructed prompt, and/or (iii) a configuration of a prompt template used to construct the constructed prompt.

In some aspects, the techniques described herein relate to a method, wherein the one or more attributes of the generative model include a type of the generative model.

In some aspects, the techniques described herein relate to a method, wherein the plurality of generative AI systems include a first generative AI system, and wherein the method further includes: providing, by the one or more processors for display by a user device, a visual representation of an embedding space of the knowledge base of the first generative AI system.

In some aspects, the techniques described herein relate to a method, wherein the visual representation of the embedding space includes a plurality of topic labels indicating the topics of a respective plurality of clusters of embeddings.

In some aspects, the techniques described herein relate to a method, wherein the plurality of topic labels includes a first topic label, wherein the plurality of clusters of embeddings includes a first embedding cluster, wherein the first topic label indicates a topic of the first embedding cluster, and wherein the method further includes automatically generating the first topic label.

In some aspects, the techniques described herein relate to a method, wherein automatically generating the first topic label includes: selecting one or more embeddings of the first embedding cluster; obtaining one or more portions of source data of the knowledge base represented by the one or more embeddings; and prompting a generative model to identify a topic of the one or more portions of the source data, wherein the topic of the first embedding cluster is the topic of the one or more portions of the source data.

In some aspects, the techniques described herein relate to a method, wherein the visual representation of the embedding space identifies one or more embedding clusters in the plurality of embedding clusters as outliers.

In some aspects, the techniques described herein relate to a method, further including providing a recommendation to remove the one or more embedding clusters identified as outliers from the knowledge base.

In some aspects, the techniques described herein relate to a method, further including providing a recommendation to configure the prompt construction facility to filter out embeddings retrieved from the one or more embedding clusters identified as outliers.

In some aspects, the techniques described herein relate to a method, wherein the evaluation dataset is a synthetic evaluation dataset.

In some aspects, the techniques described herein relate to a method, further including constructing the synthetic evaluation dataset.

In some aspects, the techniques described herein relate to a method, wherein, for each generative AI system in the plurality of generative AI systems, the one or more quantitative metrics include: a factual accuracy metric indicating an extent to which completions generated by the respective generative AI system in response to the plurality of queries are factual; a faithfulness metric indicating an extent to which the completions generated by the respective generative AI system include hallucinated information; a grounded-ness metric indicating an extent to which the completions generated by the respective generative AI system are based on context data extracted from the knowledge base of the respective generative AI system; a toxicity metric indicating an extent to which the completions generated by the respective generative AI system include toxic content; a latency metric indicating a latency associated with the processing of the queries and/or generation of the completions by the respective generative AI system; a token count metric derived from a number of tokens included in the completions generated by the respective generative AI system; and/or a cost metric indicative a cost incurred by using the generative model of the respective generative AI system to generate the completions.

In some aspects, the techniques described herein relate to an AI development system including: one or more processors; one or more computer-readable storage media storing instructions that, when executed by the one or more processors, cause the one or more processors to perform operations including: constructing, by one or more processors, a plurality of generative AI systems, wherein constructing the plurality of generative AI systems includes executing at least one modeling blueprint; providing, by the one or more processors, a plurality of queries to each generative AI system in the plurality of generative AI systems, the plurality of queries being part of an evaluation dataset; during processing of the plurality of queries by each generative AI system, monitoring values of one or more quantitative metrics; providing, by the one or more processors for display by a user device, data indicating the values of the one or more quantitative metrics for each generative AI system; and providing, by the one or more processors for display by the user device, a recommendation regarding use or non-use of at least one generative AI system included in the plurality of generative AI systems.

In some aspects, the techniques described herein relate to a computer-readable storage medium storing instructions that, when executed by one or more processors, cause the one or more processors to perform operations including: constructing, by one or more processors, a plurality of generative AI systems, wherein constructing the plurality of generative AI systems includes executing at least one modeling blueprint; providing, by the one or more processors, a plurality of queries to each generative AI system in the plurality of generative AI systems, the plurality of queries being part of an evaluation dataset; during processing of the plurality of queries by each generative AI system, monitoring values of one or more quantitative metrics; providing, by the one or more processors for display by a user device, data indicating the values of the one or more quantitative metrics for each generative AI system; and providing, by the one or more processors for display by the user device, a recommendation regarding use or non-use of at least one generative AI system included in the plurality of generative AI systems.

In some aspects, the techniques described herein relate to a method including: obtaining, by one or more processors, one or more first completions generated by a generative AI system in response to a query; determining, by the one or more processors, a first value of a scoring metric for the query based on the one or more first completions; for each word of a plurality of words in the query, constructing, by the one or more processors, a masked query based on the query, wherein the respective word is masked or removed; obtaining, by the one or more processors, one or more second completions generated by the generative AI system in response to the respective masked query; determining, by the one or more processors, a second value of the scoring metric for the respective masked query based on the one or more second completions; and determining, by the one or more processors, a word impact score of the respective word based on a difference between (i) the second value of the scoring metric for the masked query in which the word is masked or removed, and (ii) the first value of the scoring metric for the query; and based on the word impact scores of the plurality of words, providing guidance relating to the query for display by a user device.

In some aspects, the techniques described herein relate to a method, wherein each query in the plurality of queries includes a user input or a constructed prompt.

In some aspects, the techniques described herein relate to a method, wherein the guidance includes a visual representation of the word impact scores of the plurality of words.

In some aspects, the techniques described herein relate to a method, wherein the guidance identifies one or more words in the plurality of words having word impact scores below a threshold score, and recommends revising the query to remove or replace the one or more words.

In some aspects, the techniques described herein relate to a system including: one or more processors; one or more computer-readable storage media storing instructions that, when executed by the one or more processors, cause the one or more processors to perform operations including: obtaining, by one or more processors, one or more first completions generated by a generative AI system in response to a query; determining, by the one or more processors, a first value of a scoring metric for the query based on the one or more first completions; for each word of a plurality of words in the query, constructing, by the one or more processors, a masked query based on the query, wherein the respective word is masked or removed; obtaining, by the one or more processors, one or more second completions generated by the generative AI system in response to the respective masked query; determining, by the one or more processors, a second value of the scoring metric for the respective masked query based on the one or more second completions; and determining, by the one or more processors, a word impact score of the respective word based on a difference between (i) the second value of the scoring metric for the masked query in which the word is masked or removed, and (ii) the first value of the scoring metric for the query; and based on the word impact scores of the plurality of words, providing guidance relating to the query for display by a user device.

In some aspects, the techniques described herein relate to a computer-readable storage medium storing instructions that, when executed by one or more processors, cause the one or more processors to perform operations including: obtaining, by one or more processors, one or more first completions generated by a generative AI system in response to a query; determining, by the one or more processors, a first value of a scoring metric for the query based on the one or more first completions; for each word of a plurality of words in the query, constructing, by the one or more processors, a masked query based on the query, wherein the respective word is masked or removed; obtaining, by the one or more processors, one or more second completions generated by the generative AI system in response to the respective masked query; determining, by the one or more processors, a second value of the scoring metric for the respective masked query based on the one or more second completions; and determining, by the one or more processors, a word impact score of the respective word based on a difference between (i) the second value of the scoring metric for the masked query in which the word is masked or removed, and (ii) the first value of the scoring metric for the query; and based on the word impact scores of the plurality of words, providing guidance relating to the query for display by a user device.

In some aspects, the techniques described herein relate to a method including: selecting, by one or more processors, a plurality of clusters of embeddings from an embedding space of a knowledge base; for each cluster of embeddings in the plurality of clusters of embeddings, selecting, by the one or more processors, one or more embeddings from the respective cluster of embeddings; obtaining a respective portion of source data represented by the selected one or more embeddings; constructing, by the one or more processors, a prompt based on the obtained portion of source data, wherein the prompt relates to generating a question about the portion of source data and an answer to the question; providing the prompt as input to a generative model; and adding, by the one or more processors, the question and the answer generated by the generative model in response to the prompt to a synthetic evaluation dataset, wherein the prompt and the completion are included in a respective validation pair; providing, by the one or more processors, a first prompt to a generative AI system, the first prompt including a first question of a first validation pair of the synthetic evaluation dataset; comparing, by the one or more processors, a completion generated by the generative AI system in response to the first question and a first answer included in the first validation pair; providing, by the one or more processors, an assessment of the generative AI system based on a result of the comparing.

In some aspects, the techniques described herein relate to a method, wherein the assessment is a quantitative assessment.

In some aspects, the techniques described herein relate to a method, wherein the assessment is a qualitative assessment.

In some aspects, the techniques described herein relate to a method, wherein the qualitative assessment indicates a topic of the completion generated by the generative AI system.

In some aspects, the techniques described herein relate to a method, wherein the qualitative assessment indicates whether the topic of the completion generated by the generative AI system matches a topic of the first answer.

In some aspects, the techniques described herein relate to a system including: one or more processors; one or more computer-readable storage media storing instructions that, when executed by the one or more processors, cause the one or more processors to perform operations including: selecting, by one or more processors, a plurality of clusters of embeddings from an embedding space of a knowledge base; for each cluster of embeddings in the plurality of clusters of embeddings, selecting, by the one or more processors, one or more embeddings from the respective cluster of embeddings; obtaining a respective portion of source data represented by the selected one or more embeddings; constructing, by the one or more processors, a prompt based on the obtained portion of source data, wherein the prompt relates to generating a question about the portion of source data and an answer to the question; providing the prompt as input to a generative model; and adding, by the one or more processors, the question and the answer generated by the generative model in response to the prompt to a synthetic evaluation dataset, wherein the prompt and the completion are included in a respective validation pair; providing, by the one or more processors, a first prompt to a generative AI system, the first prompt including a first question of a first validation pair of the synthetic evaluation dataset; comparing, by the one or more processors, a completion generated by the generative AI system in response to the first question and a first answer included in the first validation pair; providing, by the one or more processors, an assessment of the generative AI system based on a result of the comparing.

In some aspects, the techniques described herein relate to a computer-readable storage medium storing instructions that, when executed by one or more processors, cause the one or more processors to perform operations including: selecting, by one or more processors, a plurality of clusters of embeddings from an embedding space of a knowledge base; for each cluster of embeddings in the plurality of clusters of embeddings, selecting, by the one or more processors, one or more embeddings from the respective cluster of embeddings; obtaining a respective portion of source data represented by the selected one or more embeddings; constructing, by the one or more processors, a prompt based on the obtained portion of source data, wherein the prompt relates to generating a question about the portion of source data and an answer to the question; providing the prompt as input to a generative model; and adding, by the one or more processors, the question and the answer generated by the generative model in response to the prompt to a synthetic evaluation dataset, wherein the prompt and the completion are included in a respective validation pair; providing, by the one or more processors, a first prompt to a generative AI system, the first prompt including a first question of a first validation pair of the synthetic evaluation dataset; comparing, by the one or more processors, a completion generated by the generative AI system in response to the first question and a first answer included in the first validation pair; providing, by the one or more processors, an assessment of the generative AI system based on a result of the comparing.

In some aspects, the techniques described herein relate to a method including: during processing of a query by a generative AI system, applying a guardrail model to a data object received or provided by the generative AI system, wherein the guardrail model is trained to detect violation of one or more conditions; determining, based on an output of the guardrail model, that the data object violates at least one of the conditions; and prior to or in lieu of the generative AI system outputting a completion in response to the query, initiating moderation of the processing of the query.

In some aspects, the techniques described herein relate to a method, wherein the guardrail model includes a predictive model or a generative model.

In some aspects, the techniques described herein relate to a method, further including retraining or tuning the guardrail model based on user feedback.

In some aspects, the techniques described herein relate to a method, wherein initiating moderation of the processing of the query includes preventing the outputting of the completion by the generative AI system.

In some aspects, the techniques described herein relate to a method, wherein initiating moderation of the processing of the query includes providing an alert indicating that the data object violates the at least one of the conditions.

In some aspects, the techniques described herein relate to a method, wherein initiating the moderation of the processing of the query further includes providing a recommendation regarding revising the query to avoid violating the at least one of the conditions.

In some aspects, the techniques described herein relate to a method, wherein the one or more conditions include a prohibition on inclusion of personally identifiable information (PII) in the data object.

In some aspects, the techniques described herein relate to a method, wherein the one or more conditions include a prohibition on toxic content in the data object.

In some aspects, the techniques described herein relate to a method, wherein the one or more conditions include a prohibition on use of prompt injection techniques.

In some aspects, the techniques described herein relate to a method, wherein the one or more conditions include a prohibition on a topic of the data object.

In some aspects, the techniques described herein relate to a method, wherein the one or more conditions include a prohibition on a sentiment of the data object.

In some aspects, the techniques described herein relate to a method, wherein the data object includes the query, content retrieved from a knowledge base, context data added to a constructed prompt, the constructed prompt, or the completion.

In some aspects, the techniques described herein relate to a method, further including: determining, by a monitoring model, a value of a metric indicative of a performance of the generative AI system during the processing of the query.

In some aspects, the techniques described herein relate to a method, wherein the metric is a quantitative metric.

In some aspects, the techniques described herein relate to a method, wherein the monitoring model includes a predictive model or a generative model.

In some aspects, the techniques described herein relate to a method, further including retraining or tuning the monitoring model based on user feedback.

In some aspects, the techniques described herein relate to a system including: one or more processors; one or more computer-readable storage media storing instructions that, when executed by the one or more processors, cause the one or more processors to perform operations including: during processing of a query by a generative AI system, applying a guardrail model to a data object received or provided by the generative AI system, wherein the guardrail model is trained to detect violation of one or more conditions; determining, based on an output of the guardrail model, that the data object violates at least one of the conditions; and prior to or in lieu of the generative AI system outputting a completion in response to the query, initiating moderation of the processing of the query.

In some aspects, the techniques described herein relate to a computer-readable storage medium storing instructions that, when executed by one or more processors, cause the one or more processors to perform operations including: during processing of a query by a generative AI system, applying a guardrail model to a data object received or provided by the generative AI system, wherein the guardrail model is trained to detect violation of one or more conditions; determining, based on an output of the guardrail model, that the data object violates at least one of the conditions; and prior to or in lieu of the generative AI system outputting a completion in response to the query, initiating moderation of the processing of the query.

The foregoing is a non-limiting summary of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram of a generative AI system that uses retrieval-augmented generation (RAG), according to some embodiments.

FIG. 2A is a block diagram of an AI development system, according to some embodiments.

FIG. 2B is a flow diagram of a method for building and evaluating RAG-based AI systems, according to some embodiments.

FIG. 3A is a block diagram of an AI monitoring system, according to some embodiments.

FIG. 3B is a flow diagram of a method for monitoring a RAG-based AI system, according to some embodiments.

FIG. 4 is a flow diagram of a method for generating a synthetic evaluation dataset, according to some embodiments.

FIG. 5 is a flow diagram of a method for monitoring values of metrics to characterizing generative AI systems, according to some embodiments.

FIG. 6A is a flow diagram of a method for updating a monitoring model of an AI monitoring system, according to some embodiments.

FIG. 6B a flow diagram of another method for updating a monitoring model of an AI monitoring system, according to some embodiments.

FIG. 6C is a block diagram of a generative AI system for generating responses to Requests for Proposal (RFPs), according to some embodiments.

FIG. 6D is an example of a visualization of a knowledge base's embedding space, according to some embodiments.

FIG. 7A is a flow diagram of a method for assessing word impact in a generative AI system, according to some embodiments.

FIG. 7B is an equation for use in assessing word impact, according to some embodiments.

FIG. 7C is an example of a visualization of the results of a word impact assessment, according to some embodiments.

FIG. 7D is a flow diagram of another method for assessing word impact in a generative AI system, according to some embodiments.

FIG. 8 is a flow diagram of yet another method for assessing word impact, according to some embodiments.

FIG. 9 is a block diagram depicting the use of an AI system assessment facility to assess the prompts of a generative AI system, according to some embodiments.

FIG. 10 is a flow diagram of a completion assessment method, according to some embodiments.

FIG. 11 is a flow diagram of a query generation method, according to some embodiments.

FIG. 12 is a flow diagram a method for monitoring an AI system, according to some embodiments.

FIG. 13 is a block diagram of an example computer system, according to some embodiments.

### DETAILED DESCRIPTION

### Generative AI and Deep Learning (DL)

Gen AI technology generally utilizes generative models such as Generative Adversarial Networks (GANs), transformer-based models, diffusion models (e.g., stable diffusion models), and/or Variational Autoencoders (VAEs), etc., which are based on artificial neural networks and deep learning. Deep Learning (DL) is a subset of ML that focuses on artificial neural networks (ANN) and their ability to learn and make decisions. Deep Learning involves the use of complex algorithms to train ANNs to recognize patterns and make predictions based on large amounts of data. The key difference between DL and traditional ML algorithms is that DL algorithms can learn multiple layers of representations, allowing them to model highly nonlinear relationships in the data. This makes them particularly effective for applications such as image and speech recognition, natural language processing (NPL), etc.

Most DL methods use ANN architectures, which is why DL models are often referred to as deep neural networks (DNNs). The term “deep” refers to the number of hidden layers in the neural network. For example, a traditional ANN may only contain 2-3 hidden layers, while DNNs can have as many as 150 layers (or more). DL uses these multiple layers to progressively extract higher-level features from the raw input. For example, in image processing, lower layers may identify edges, while higher layers may identify the concepts relevant to a human, such as digits or letters or faces. DL models are trained by using large sets of labeled data and ANN architectures that learn features directly from the data without the need for manual feature extraction.

### Hyperparameters and Hyperparameter Tuning

Hyperparameters are external configuration variables that control or guide machine learning model training. In other words, hyperparameters are parameters that control the learning process and thereby influence the ultimate structure of the model and the learned values of the model parameters. Many hyperparameters are used to guide the training of DNNs, such as the size (number of layers and number of units per layer), the learning rate (e.g., a tuning parameter in an optimization algorithm that determines the step size at each iteration while moving toward a minimum of a loss function), and initial weights of model parameters.

The process of training an ANN involves choosing hyperparameter values that control and guide the learning algorithm. The process of experimenting with different hyperparameter values to find a suitable or optimum hyperparameter set is known as hyperparameter tuning or hyperparameter optimization. Hyperparameter tuning is an important aspect of developing ML tools and AI systems, because the selected set of hyperparameters can have a significant impact on model performance and accuracy. For example, if the learning rate hyperparameter of an ANN training algorithm is too high, the model may converge too quickly with suboptimal results. On the other hand, if the learning rate is too low, training may take too long and results may not converge. Auto ML tools may assist with or control the hyperparameter turning process.

### Large Language Models (LLM) and Transformer Networks

In many Gen AI systems, the generative model that generates content is a large language model (LLM). A large language model (LLM) is a type of ML model that can perform a variety of natural language processing (NLP) tasks such as generating and classifying text, answering questions in a conversational manner, and translating text from one language to another. The term ‘large’ refers to the number of values (parameters) the language model can change autonomously as it learns. Some LLMs have hundreds of billions of parameters. In general, LLMs are NN models that have been trained using deep learning techniques to recognize, summarize, translate, predict, and generate content using very large datasets.

Many state-of-the-art LLMs use a class of deep learning architectures called transformer neural networks (“transformer networks” or “transformers”). A transformer is a neural network that learns context and meaning by tracking relationships between data units, such as the words in a sentence. A transformer can include multiple transformer blocks, also known as layers. For example, a transformer may have self-attention layers, feed-forward layers, and normalization layers, all working together to decipher input to predict (or generate) streams of relevant output. The layers can be stacked to make deeper transformers and powerful language models.

Two key innovations that make transformers particularly adept for large language models: positional encodings and self-attention. Positional encoding embeds the order in which the input occurs within a given sequence. Rather than feeding words within a sentence sequentially into the neural network, with positional encoding, the words can be fed in non-sequentially. Self-attention assigns a weight to each part of the input data while processing it. This weight signifies the importance of that portion of the input in the context of the rest of the input. The use of the attention mechanism enables models to focus on the parts of the input that matter the most. This representation of the relative importance of different inputs to the neural network is learned over time as the model sifts and analyzes data. These two techniques in conjunction allow for analyzing the subtle ways and contexts in which distinct elements influence and relate to each other over long distances, non-sequentially. The ability to process data non-sequentially enables the decomposition of the complex problem into multiple, smaller, simultaneous computations.

“Completion” may refer to the process of a generative model generating additional content (e.g., text) based on a provided prompt (e.g., text), e.g., providing the next word in a sentence. The additional content (e.g., text) provided by the generative model may be referred to herein as a “completion.” Completions generated by generative models may include text, audio data (e.g., speech, music, etc.), image data (e.g., images), video data (e.g., videos), time-series data, or any other suitable type of data. “Prompting” may refer to a technique in which a generative model (e.g., an LLM) is matched to a desired downstream task by formulating the task as natural language text explaining the desired behavior, such that a generative model can carry out the task by performing text completion. Often these instructions are split into a “system message” containing general task instructions providing general guidance about the desired behavior and a “prompt template” containing the portion of the prompt that contains indicator values that are substituted in each use. “Fine-tuning” may refer to the process whereby a generative model is adapted to a particular task by changing its parameters by providing prompts with desired completions.

Generative models can analyze existing content, identify patterns in the content, and combine or modify the identified patterns to generate new content. The new content can include text, images, video, music, or any other suitable type of content. Some non-limiting examples of generative models include generative adversarial networks (GANs), variational autoencoders (VAEs), autoregressive models (e.g., large language models (LLMs)), recurrent neural networks (RNNs), transformer-based models, reinforcement learning models for generative tasks, etc. Transformer-based models generally have an encoder-decoder architecture, use an attention mechanism (e.g., scaled dot-product attention, multi-head attention, masked attention, etc.) to model the relationships between different elements in a sequence of content, and perform well when processing long sequences of content. Some non-limiting examples of transformer-based models include Generalized Pre-trained Transformer 4 (GPT-4), DALL-E3, etc. Other examples of generative models with text-processing capability include Jurassic-1, Command, and Paradigm. Generative models can benefit from hyperparameter tuning to tweak the model's performance for desired results, as discussed above.

### Terms

Many of the examples and embodiments disclosed herein are described with respect to a knowledge base. However, the techniques described herein can be applied to any type of “grounding data” for generative AI systems (e.g., retrieval-augmented generation (RAG)-based generative AI systems) including but not limited to knowledge bases and/or other information sources.

The term “generative model” as used herein may generally refer to a type of machine learning model that is trained on existing data to enable the generative model to generate, based on an input or prompt, new data that shares characteristics similar to that of the training data. In some examples, a generative model may handle text. In these examples, the generative model may accept text prompts and produce text outputs. Any suitable type of AI model can be used, including predictive models, generative AI (“Gen AI”) models, etc. Predictive models can analyze historical data, identify patterns in that data, and make inferences (e.g., produce predictions or forecast outcomes) based on the identified patterns. Some non-limiting examples of predictive models include neural networks (e.g., deep neural networks (DNNs), convolutional neural networks (CNNs), recurrent neural networks (RNNs), learning vector quantization (LVQ) models, etc.), regression models (e.g., linear regression models, logistic regression models, linear discriminant analysis (LDA) models, etc.), decision trees, random forests, support vector machines (SVMs), naïve Bayes models, classifiers, etc.

As used herein, “data analytics” may refer to the process of analyzing data (e.g., using machine learning models or techniques) to discover information, draw conclusions, and/or support decision-making. Species of data analytics can include descriptive analytics (e.g., processes for describing the information, trends, anomalies, etc. in a dataset), diagnostic analytics (e.g., processes for inferring why specific trends, patterns, anomalies, etc. are present in a dataset), predictive analytics (e.g., processes for predicting future events or outcomes), and prescriptive analytics (processes for determining or suggesting a course of action).

“Machine learning” may refer to the application of certain techniques (e.g., pattern recognition and/or statistical inference techniques) by computer systems to perform specific tasks. Machine learning techniques (automated or otherwise) may be used to build data analytics models based on sample data (e.g., “training data”) and to validate the models using validation data (e.g., “testing data”). The sample and validation data may be organized as sets of records (e.g., “observations” or “data samples”), with each record indicating values of specified data fields (e.g., “independent variables,” “inputs,” “features,” or “predictors”) and corresponding values of other data fields (e.g., “dependent variables,” “outputs,” or “targets”). Machine learning techniques may be used to train models to infer the values of the outputs based on the values of the inputs. When presented with other data (e.g., “inference data”) similar to or related to the sample data, such models may accurately infer the unknown values of the targets of the inference dataset.

A feature of a data sample may be a measurable property of an entity (e.g., person, thing, event, activity, etc.) represented by or associated with the data sample. In some cases, a feature of a data sample is a description of (or other information regarding) an entity represented by or associated with the data sample. A value of a feature may be a measurement of the corresponding property of an entity or an instance of information regarding an entity. In some cases, a value of a feature can indicate a missing value (e.g., no value). For instance, in the above example in which a feature is the price of a house, the value of the feature may be ‘NULL’, indicating that the price of the house is missing.

Features can also have data types. For instance, a feature can have a numerical data type, a categorical data type, a time-series data type, a text data type (e.g., a structured text data type or an unstructured (“free”) text data type), an image data type, a spatial data type, or any other suitable data type. In general, a feature's data type is categorical if the set of values that can be assigned to the feature is finite.

As used herein, “time-series data” may refer to data collected at different points in time. For example, in a time-series dataset, each data sample may include the values of one or more variables sampled at a particular time. In some embodiments, the times corresponding to the data samples are stored within the data samples (e.g., as variable values) or stored as metadata associated with the dataset. In some embodiments, the data samples within a time-series dataset are ordered chronologically. In some embodiments, the time intervals between successive data samples in a chronologically-ordered time-series dataset are substantially uniform.

Time-series data may be useful for tracking and inferring changes in the dataset over time. In some cases, a time-series data analytics model (or “time-series model”) may be trained and used to predict the values of a target Z at time t and optionally times t+1, . . . , t+i, given observations of Z at times before t and optionally observations of other predictor variables P at times before t. For time-series data analytics problems, the objective is generally to predict future values of the target(s) as a function of prior observations of all features, including the targets themselves.

As used herein, “image data” may refer to a sequence of digital images (e.g., video), a set of digital images, a single digital image, and/or one or more portions of any of the foregoing. A digital image may include an organized set of picture elements (“pixels”). Digital images may be stored in computer-readable file. Any suitable format and type of digital image file may be used, including but not limited to raster formats (e.g., TIFF, JPEG, GIF, PNG, BMP, etc.), vector formats (e.g., CGM, SVG, etc.), compound formats (e.g., EPS, PDF, PostScript, etc.), and/or stereo formats (e.g., MPO, PNS, JPS, etc.).

As used herein, “non-image data” may refer to any type of data other than image data, including but not limited to structured textual data, unstructured textual data, categorical data, and/or numerical data. As used herein, “natural language data” may refer to speech signals representing natural language, text (e.g., unstructured text) representing natural language, and/or data derived therefrom. As used herein, “speech data” may refer to speech signals (e.g., audio signals) representing speech, text (e.g., unstructured text) representing speech, and/or data derived therefrom. As used herein, “auditory data” may refer to audio signals representing sound and/or data derived therefrom.

As used herein, “spatial data” may refer to data relating to the location, shape, and/or geometry of one or more spatial objects. A “spatial object” may be an entity or thing that occupies space and/or has a location in a physical or virtual environment. In some cases, a spatial object may be represented by an image (e.g., photograph, rendering, etc.) of the object. In some cases, a spatial object may be represented by one or more geometric elements (e.g., points, lines, curves, and/or polygons), which may have locations within an environment (e.g., coordinates within a coordinate space corresponding to the environment).

As used herein, “spatial attribute” may refer to an attribute of a spatial object that relates to the object's location, shape, or geometry. Spatial objects or observations may also have “non-spatial attributes.” For example, a residential lot is a spatial object that that can have spatial attributes (e.g., location, dimensions, etc.) and non-spatial attributes (e.g., market value, owner of record, tax assessment, etc.). As used herein, “spatial feature” may refer to a feature that is based on (e.g., represents or depends on) a spatial attribute of a spatial object or a spatial relationship between or among spatial objects. As a special case, “location feature” may refer to a spatial feature that is based on a location of a spatial object. As used herein, “spatial observation” may refer to an observation that includes a representation of a spatial object, values of one or more spatial attributes of a spatial object, and/or values of one or more spatial features.

Spatial data may be encoded in vector format, raster format, or any other suitable format. In vector format, each spatial object is represented by one or more geometric elements. In this context, each point has a location (e.g., coordinates), and points also may have one or more other attributes. Each line (or curve) comprises an ordered, connected set of points. Each polygon comprises a connected set of lines that form a closed shape. In raster format, spatial objects are represented by values (e.g., pixel values) assigned to cells (e.g., pixels) arranged in a regular pattern (e.g., a grid or matrix). In this context, each cell represents a spatial region, and the value assigned to the cell applies to the represented spatial region.

Data (e.g., variables, features, etc.) having certain data types, including data of the numerical, categorical, or time-series data types, are generally organized in tables for processing by machine-learning tools. Data having such data types may be referred to collectively herein as “tabular data” (or “tabular variables,” “tabular features,” etc.). Data of other data types, including data of the image, textual (structured or unstructured), natural language, speech, auditory, or spatial data types, may be referred to collectively herein as “non-tabular data” (or “non-tabular variables,” “non-tabular features,” etc.).

As used herein, “data analytics model” may refer to any suitable model artifact generated by the process of using a machine learning algorithm to fit a model to a specific training dataset. The terms “data analytics model,” “machine learning model” and “machine learned model” are used interchangeably herein.

As used herein, the “development” of a machine learning model may refer to construction of the machine learning model. Machine learning models may be constructed by computers using training datasets. Thus, “development” of a machine learning model may include the training of the machine learning model using a training dataset. In some cases (generally referred to as “supervised learning”), a training dataset used to train a machine learning model can include known outcomes (e.g., labels or target values) for individual data samples in the training dataset. For example, when training a supervised computer vision model to detect images of cats, a target value for a data sample in the training dataset may indicate whether or not the data sample includes an image of a cat. In other cases (generally referred to as “unsupervised learning”), a training dataset does not include known outcomes for individual data samples in the training dataset.

Following development, a machine learning model may be used to generate inferences with respect to “inference” datasets. For example, following development, a computer vision model may be configured to distinguish data samples including images of cats from data samples that do not include images of cats. As used herein, the “deployment” of a machine learning model may refer to the use of a developed machine learning model to generate inferences about data other than the training data.

As used herein, a “modeling blueprint” (or “blueprint”) may refer to a computer-executable set of preprocessing operations, model-building operations, and postprocessing operations to be performed to develop a model or model-based system based on the input data. Blueprints may be generated “on-the-fly” based on any suitable information including, without limitation, the size of the user data, features types, feature distributions, etc. Blueprints may be capable of jointly using multiple (e.g., all) data types, thereby allowing the model to learn the associations between image features, as well as between image and non-image features. In some examples, a blueprint can include instructions, operations, etc. for developing a generative model or generative AI system (e.g., a RAG-based generative AI system).

“Computer vision” may refer to the use of computer systems to analyze and interpret image data. Computer vision tools generally use models that incorporate principles of geometry and/or physics. Such models may be trained to solve specific problems within the computer vision domain using machine learning techniques. For example, computer vision models may be trained to perform object recognition (recognizing instances of objects or object classes in images), identification (identifying an individual instance of an object in an image), detection (detecting specific types of objects or events in images), etc.

Computer vision tools (e.g., models, systems, etc.) may perform one or more of the following functions: image pre-processing, feature extraction, and detection/segmentation. Some examples of image pre-processing techniques include, without limitation, image re-sampling, noise reduction, contrast enhancement, and scaling (e.g., generating a scale space representation). Extracted features may be low-level (e.g., raw pixels, pixel intensities, pixel colors, gradients, patterns and textures (e.g., combinations of colors in close proximity), color histograms, motion vectors, edges, lines, corners, ridges, etc.), mid-level (e.g., shapes, surfaces, volumes, patterns, etc.), high-level (e.g., objects, scenes, events, etc.), or highest-level. The lower level features tend to be simpler and more generic (or broadly applicable), whereas the higher level features to be complex and task-specific. The detection/segmentation function may involve selection of a subset of the input image data (e.g., one or more images within a set of images, one or more regions within an image, etc.) for further processing. Models that perform image feature extraction (or image pre-processing and image feature extraction) may be referred to herein as “image feature extraction models.”

Collectively, the features extracted and/or derived from an image may be referred to herein as a “set of image features” (or “aggregate image feature”), and each individual element of that set (or aggregation) may be referred to as a “constituent image feature.” For example, the set of image features extracted from an image may include (1) a set of constituent image feature indicating the colors of the individual pixels in the image, (2) a set of constituent image features indicating where edges are present in the image, and (3) a set of constituent image features indicating where faces are present in the image.

As used herein, “automated machine learning platform” (e.g., “automated ML platform” or “Auto ML platform”) may refer to a computer system or network of computer systems, including the user interface, processor(s), memory device(s), components, modules, etc. that provide access to or implement automated machine learning techniques.

### Motivation for and Benefits of Some Embodiments

In recent years, advances in automated machine learning technology have substantially lowered the barriers to the development of certain types of ML tools and AI systems, particularly those that make predictions or inferences based on statistical analysis of data. Historically, the processes used to develop ML tools and AI systems suitable for carrying out specific analytic tasks generally have been expensive and time-consuming, and often have required the expertise of highly-trained data scientists. Such processes generally includes steps of data collection, data preparation, feature engineering, system development (e.g., model building, training, and/or configuration), system assessment, and/or system monitoring.

For example, Gen AI has shown promising results in information retrieval, question answering, computer vision, natural language processing, content generation (text, images, video, software code, music, audio, etc.), software development, healthcare (e.g., predicting protein structures, identifying drug candidates), motion control and navigation (e.g., for autonomous robots), and other domains. The ability of Gen AI technology to generate new content represents a significant departure from predictive AI technology, which analyzes and processes data to provide predictions and recommendations.

Existing Gen AI technology often has significant problems with bias and accuracy, and a propensity to hallucinate (e.g., produce erroneous results) or generate content having low relevance to the user's prompt (e.g., content in a different language, or information that is not responsive to the prompt). When such errors arise, they can be very difficult to diagnose and correct, due to the complexity of underlying models and the unsupervised or semi-supervised techniques by which the models are trained. This disclosure describes the application of automated machine learning (Auto ML) and/or predictive modeling techniques to the development, assessment, and/or monitoring of Gen AI systems to address these and other problems. In addition, this disclosure describes techniques for developing and deploying AI applications that include both generative and predictive models.

Large language models (LLMs) have demonstrated robust performance in a wide variety of natural language tasks, including text summarization, extraction of relevant information, disambiguation of entities, and language translation. In addition, the LLMs used in many Gen AI systems are generalized LLMs, which can be used to perform such tasks across a wide variety of knowledge domains. However, even generalized generative models (e.g., LLMs) can suffer from “knowledge cutoff” or a “knowledge gap,” whereby a generative model (e.g., an LLM) is unaware of events that occurred after the date of its training and unaware of events or information not represented in its training dataset. For example, a generalized generative model (e.g., LLM) trained using publicly available data and documents found on the Internet would be unaware of private or confidential information, such as the information contained in an organization's private, internal documents.

One technique for addressing a generative models knowledge gap is retrieval-augmented generation (RAG). Some embodiments are applied to RAG-based Gen AI systems.

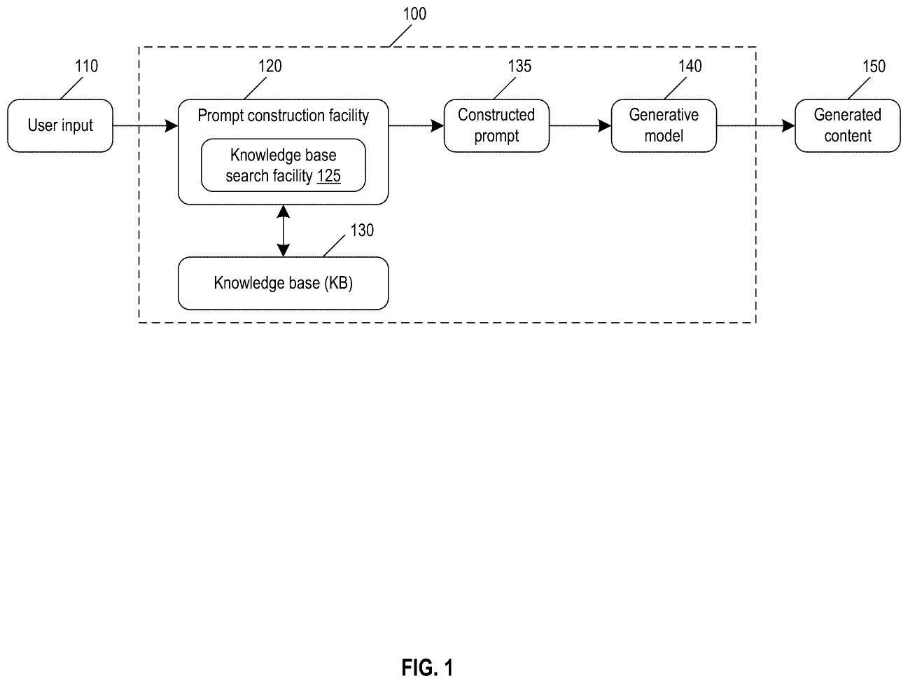

FIG. 1 is a block diagram of a Gen AI system 100 that uses retrieval-augmented generation, according to some embodiments. In the example of FIG. 1, the Gen AI system 100 includes a prompt construction facility 120, a knowledge base (KB) 130, and a generative model 140. The knowledge base 130 contains a representation of information contained in a corpus of source data. The corpus of source data may be relevant to a user, an organization, a knowledge domain, one or more topics, etc. In some embodiments, the KB 130 also includes the source data from which the KB's information representation is derived. The source data may include any suitable type of data (e.g., text, audio, image, video, time-series, etc.). In some embodiments, the information contained in the knowledge database 130 includes information that was not present in the training dataset of the generative model 140. Thus, the knowledge database 130 can address the generative model's “knowledge gap” by making such information accessible to the generative model 140. In some embodiments, the knowledge base 130 includes a structured representation (e.g., a vector representation, for example, vector embeddings) of information extracted from the source data. The generative model 140 may be any suitable generative model (e.g., a deep neural network (DNN), an LLM, a Generative Pre-trained Transformer (GPT), GPT-3, GPT-4, etc.). Any suitable technique (e.g., encoding technique) can be used to generate the knowledge base's structured representations of information.

The prompt construction facility 120 may receive user input 110 (e.g., a query or user-generated prompt) to the Gen AI system 100, construct a prompt 135 based on the user input 110 and the knowledge base 130, and provide the constructed prompt 135 as input to the generative model 140. In response to the constructed prompt, the generative model 140 generates and outputs generated content 150 (e.g., completions). The completions may include any suitable type of data (e.g., text, audio, image, video, time-series, etc.). This approach is referred to as retrieval-augmented generation because the prompt construction facility 120 (more specifically, the knowledge base search facility 125 of the prompt construction facility 120) retrieves information from the knowledge base 130 and uses that information to augment the user input 110, thereby generating the constructed prompt. The information retrieved from the KB 130 and used to augment the user input 110 may be referred to herein as “context” or “query context.” When retrieval-augmented generation is used, the generative model 140 may be used to extract information from the knowledge base 130 that is relevant to the user input, rather than (or in addition to) extracting relevant internal knowledge of the generative model 140. Thus, retrieval-augmented generation techniques can use the generative model (e.g., LLM) as a natural language interface to the knowledge base 130.

Retrieval-augmented generative AI exhibits a number of useful attributes. For example, the generative model 140 can cite the sources of information included in the generated content 150 (e.g., documents or portions of documents in the KB 130), which facilitates validation or generated content and curation of the knowledge base 130. Hallucinations are less likely to occur when relying on the information in the knowledge base rather than the internal knowledge of the generative model 140 to response to the prompt. The knowledge base 130 can be pruned, augmented, otherwise updated, or even swapped out for a completely different knowledge base 130 without changing the generative model 140, and vice versa. In this way, the generative AI system's performance can be improved by maintaining and/or updating the knowledge database and improving the performance of the prompt construction facility—tasks which are generally much easier and less costly than retraining the generative model (e.g., LLM).

Developing a high-quality retrieval-augmented Gen AI system 100 presents many challenges. For example, generating a knowledge base 130 involves making a large number of data science decisions, such as setting the chunk size, selecting an embedding model and specifying values for the embedding model's configurable settings, choosing a matching approach (e.g., an algorithm for matching user queries with relevant embeddings in the KB), etc. As another example, it can be difficult to determine what information is in the knowledge base (in the raw text of the source dataset (e.g., document corpus) and/or in the embeddings that represent concepts extracted from the source dataset). In some cases, documents that the user would prefer to exclude from the KB (e.g., documents containing private, non-public, or proprietary information) may inadvertently be included in the KB, while documents that the user would prefer to include in the KB (e.g., documents addressing concepts that the Gen AI system is intended to understand) may inadvertently be excluded from the KB. In addition, when the KB fails to return relevant information in response to a query (“lookup failure”), it can be difficult to determine why the KB did not return relevant information or how the failure can be remedied. For example, when processing a user input (query) existing Gen AI systems tend to provide only the generated content and perhaps a reference to the documents on which the generated content is based, which makes it difficult to understand which portions of the prompt matched useful concepts in the KB and which portions of the prompt matched irrelevant or unwanted concepts in the KB.

The inventors have recognized and appreciated that improved retrieval-augmented Gen AI systems 100 can be developed by using Auto ML techniques (e.g., Bayesian Hyperparameter optimization) to make the data science decisions involved in the generation of the knowledge base (e.g., selecting hyperparameter values), to assess the attributes of different knowledge bases (e.g., knowledge bases created using different values for the relevant hyperparameters), and to assess the performance of the Gen AI system with the different knowledge bases. For example, Auto ML techniques may be used to set the values of the hyperparameters that control the process of generating a knowledge base from a source dataset (e.g., document corpus), to evaluate the different versions of the knowledge base generated using the different hyperparameter values, and to select the version of the knowledge base that has the desired attributes or yields the desired level of performance. The Gen AI system 100 can then be deployed using the selected version of the knowledge base. Some embodiments of a method for using Auto ML techniques to build and evaluate different versions of a KB are described herein.

The inventors have recognized and appreciated that improved retrieval-augmented Gen AI systems 100 can be developed by providing time-filtering capabilities with respect to the knowledge base. Time filtering refers to filtering the information available to the knowledge base so that only information dated in a particular date/time range (e.g., prior to a specified date/time) is used to respond to a query. In some embodiments, time filtering is performed when the knowledge base is generated, for example, by filtering out any documents published outside the date/time range of interest before generating the knowledge base. In some embodiments, metadata associated with the embeddings and/or documents in the knowledge base indicate a date/time associated with the corresponding information, and the results returned by the knowledge base in response to a query are dynamically screened to filter out information associated with dates/times outside the range of interest.

The techniques described herein may be used to improve any knowledge base, and may be particularly well-suited to improving retrieval-augmented Gen AI systems. In some cases, these techniques may be applied to Gen AI systems configured to function as retrieval bots that retrieve relevant information in response to a query.

Deploying a generative AI system (e.g., content generation system, information retrieval system, question answering system, etc.) generally involves monitoring components of the system, inputs to the system (or components thereof), and outputs from the system (or components thereof). A wide variety of events can perturb the AI system's performance or the quality of the AI system's outputs. For example, components of the AI system that receive inputs from users can receive adversarial inputs or off-topic inputs. Updates to the knowledge base or to the system's generative model(s) (e.g., LLMs) can change the quality of the AI system's outputs in unexpected ways. Replacing or updating a component of the AI system can cause computational performance to improve or deteriorate.

In some embodiments, monitoring models (e.g., predictive models trained to monitor various aspects of an AI system's performance) are used to monitor the performance of an AI system's components. For example, monitoring models can be used to automatically monitor (e.g., measure and/or track) and report the values of quantitative and/or qualitative metrics indicative of the performance of the AI system (or its components).

Some examples of quantitative metrics indicative of the performance of an AI system (or its components) may include factualness/factual accuracy, faithfulness, grounded-ness, toxicity/appropriateness, correctness, and/or topicality of generated content (e.g., one or more “completions”) provided by the generative model; latency and/or cost (e.g., the time and/or financial cost associated with submitting a particular prompt and/or receiving a specific completion from the generative model 140), token counts (e.g., prompt tokens, response tokens, document tokens, and/or total tokens used to generate a response), the risk that a completion contains personally identifiable information (PII), etc. Likewise, drift detection models and/or anomaly detection models (e.g., cluster analysis tools) can be applied to (i) the source data (e.g., document corpus) from which the knowledge base is generated (to detect drift and/or anomalies in the source text), (ii) the prompts provided to the generative model (to detect drift and/or anomalies in the prompts), and/or (iii) the content generated by the generative model (to detect drift and/or anomalies in the generated content). In addition, drift detection models can be applied to the streams of metric values produced by the metric monitoring models over time.

In some embodiments, moderation tools can be used to provide guardrails that prevent or discourage users from attempting to use a generative AI system in unintended or unwanted ways. In some embodiments, one or more of the moderation tools may include a monitoring model. For example, if an AI system is intended to retrieve information or generate answers about a specific set of topics, a monitoring model (e.g., a “topicality monitoring model” or “topicality model”) may be used to determine whether a query is related to one of the supported topics or to an unsupported topic. If the topicality model indicates that the query is related to an unsupported topic, an AI monitoring system may apply a “guardrail” by alerting the user that the query is not supported and/or preventing the generative model of the generative AI system from processing the query. In this way, the AI monitoring system may provide a helpful error message to the user rather than the generative AI system generating a response that is untruthful, incorrect, hallucinatory, etc. Likewise, guardrails may be used to prevent the user from querying the generative AI system with malicious or toxic input. Other guardrails can include prompt injection detection tools (e.g., tools that detect inputs manipulated to overwrite or alter system prompts and/or templates in ways intended to cause the model to output unintended responses), sentiment classifiers (e.g., models that classify text sentiments within a set of categories, e.g., ‘positive’, ‘negative’, etc.), and/or toxicity detection tools (e.g., tools that prevent or limit dissemination of untrue or harmful information). In some embodiments, the AI system may allow users to provide custom moderation tools (e.g., guardrails incorporating user-provided predictive models) that allow AI system providers to further curate and/or moderate the AI system's inputs and/or outputs.

In some embodiments, reporting tools can use monitoring models and/or additional generative models can be used to explain changes detected by the monitoring models. For example, when drift in the content (e.g., completions) generated by an AI system's generative model 140 is detected, the outputs of other monitoring models may indicate whether the completions drifted in response to drift in the user inputs, the constructed prompts, or the information provided by the knowledge base. In some embodiments, monitoring models may be used to generate embeddings for the AI system's completions and identify the topics associated with those embeddings. In some embodiments, monitoring models may assess the AI system's sensitivity to various words (e.g., in the user input) and alert the user when high-sensitivity words are used. In some embodiments, one or more generative models may be used to automatically generate text explaining the outputs of the monitoring models using natural language. Visualizations of the monitored metric values and/or the corresponding explanations can be provided to the user in real time (e.g., in a system monitoring dashboard). In some embodiments, the AI monitoring system may be configured with thresholds or ranges related to the metric values, and the AI monitoring system may alert the user when the value of a metric exceeds a corresponding threshold or departs from a specified range.

One advantage of inserting monitoring models into the AI system at the component level (rather than simply monitoring inputs to the AI system and outputs from the AI system) is that the outputs of such models make it easier to determine which components of the AI system are causing the AI system to operate in unexpected or undesirable ways. In addition or in the alternative, when a monitoring model detects a potential problem (e.g., drift or an anomaly in a monitored input or output, an off-topic input, etc.), the AI monitoring system can alert the user to the presence of the issue, provide an explanation of the issue, and/or recommend remedial action (e.g., avoiding sensitive words in prompts, removing a portion of the knowledge base that is returning information of low relevance, etc.).

However, when predictive models are used for monitoring, the monitoring models may need to be updated quickly and/or frequently (e.g., based on user feedback) to remain up-to-date as the AI system's components or the user-provided inputs change. In some embodiments, new training records can be automatically generated based on user feedback (e.g., the user's response to alerts or recommendations generated by the monitoring models), thereby augmenting the training datasets for the monitoring models. In this way, the monitoring models can be automatically retrained and redeployed based on the user's responses to the models' outputs.

Likewise, when predictive models are used for monitoring, the monitored components (e.g., generative models, knowledge bases, text generation models, prompting templates, etc.) may need to be updated from time to time (e.g., based on user feedback and/or based on the outputs of the monitoring models). In some embodiments, new training records can be automatically generated based on user feedback or based on the outputs of the monitoring models, thereby augmenting the training datasets for the monitored components. In this way, the monitored components can be automatically retrained and redeployed based on the user feedback and/or the outputs of the monitoring models. In some embodiments, the automatic retraining and redeployment is carried out by an AI monitoring system.

Updating system components of an AI system or monitoring models of an AI monitoring system in place, without interfering with the monitored AI system, can be difficult. In some embodiments, in situ evaluation of candidate system components and monitoring models can reduce or minimize disruption for users, while enabling the AI system to quickly adapt to changes. For example, candidate components and/or models can be deployed in parallel with existing components and/or models, in a shadow configuration, such that the outputs of the candidates components and/or models are monitored but are not provided to the user until their performance has been validated and/or their use has been authorized by the user.

Using the techniques described herein, operators of generative AI systems are likely to observe reduced occurrences of severe undesirable behavior leading to customer complaints, reduced legal liability, and/or reduced observation or poor performance relative to humans. Using the techniques described herein, updates to generative AI systems are more likely to deliver better performance, with reduced disruptions and results better aligned to user expectations.

The inventors have recognized and appreciated that improved retrieval-augmented generative AI systems 100 can be developed by assessing the extent to which individual tokens (e.g., words) or sets of tokens in a query (e.g., user input or constructed prompt) influence which concepts (e.g., embeddings) in the knowledge base match the query. Such assessments may be referred to herein as “similarity importance,” “word importance,” “word impact,” “similarity matching,” or “sensitivity analysis.” Using word impact metrics, a generative AI system can highlight or otherwise identify the specific tokens in the query that led a generative model to generated content related to a particular topic in response to the query, or led a prompt construction facility to retrieve embeddings from the knowledge base related to a particular topic in response to the query. Some embodiments of methods for assessing word impact are described herein.

Providing word impact assessments enables the user, an AI development system, or an AI monitoring system to adjust queries to improve the relevance of the matching information returned by the knowledge base. In addition, providing word impact assessments enables the generative AI system to label the topics represented by embeddings and documents in the knowledge base. Such topic labeling enables the generative AI system to generate visualizations of the knowledge base's embedding space, which can help users identify gaps (missing information) and/or junk (unwanted information) in the knowledge base (KB). New source data (e.g. documents) with the missing information can then be added to the KB, and the source data (and embeddings) representing the unwanted information can be removed from the KB, thereby producing an enhanced KB with a higher percentage of information relevant to the intended knowledge domain. Such topic labeling also facilitates the use of Auto ML techniques to automatically curate the knowledge base (e.g., by identifying clusters of embeddings related to unwanted concepts and removing those embeddings and the corresponding source data from the knowledge base).

In some embodiments, one or more of the systems described herein may evaluate word importance for various words that appear in, for example, an evaluation dataset (and/or for the outputs generated by a generative AI system in response to various inputs, such as the inputs contained in an evaluation dataset). Identifying word importance can help inform tuning and creation of prompt construction facilities.

In some examples, a generative AI system developed or monitored using the techniques described herein may be configured to operate as a chat bot (e.g., customer service chat bot), a natural language interface to a knowledge base, a generator of digital image, audio, and/or video content, a software (code) developer, a language translator, a document drafting service, etc.

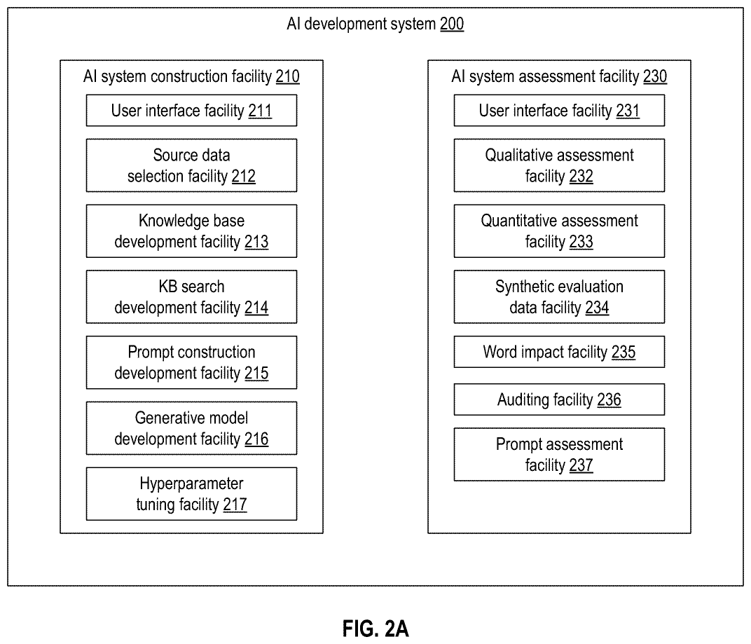

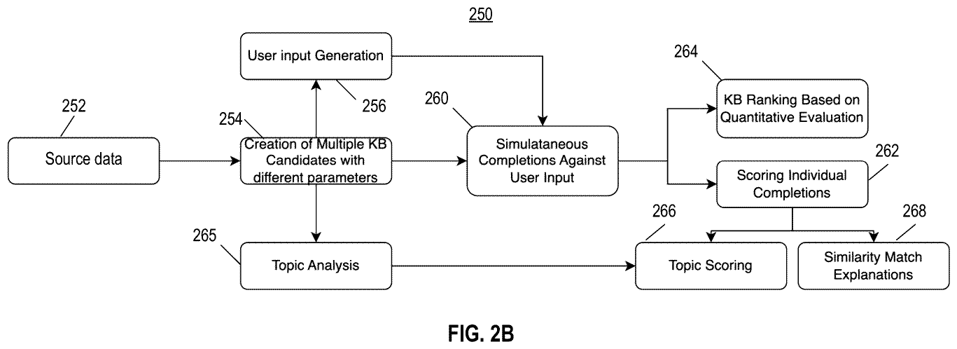

FIG. 2A shows a block diagram an AI development system 200, according to some embodiments. The AI development system 200 provides facilities for developing a RAG-based generative AI systems. In some embodiments, the AI development system 200 includes an AI system construction facility 210 and an AI system assessment facility 230. In some embodiments, the AI system construction facility 210 includes facilities for constructing the components of a generative AI system (e.g., a RAG-based generative AI system). In some embodiments, the AI system construction facility 210 uses automated machine learning techniques to assist a user in the development of a RAG-based generative AI system, and/or to automate aspects of the development of a RAG-based AI system. In some embodiments, the AI system assessment facility 230 includes facilities for assessing a generative AI system (e.g., a RAG-based generative AI system). Assessing a generative AI system can include monitoring and/or explaining the performance of a generative AI system.

The AI system construction facility 210 can include a user interface facility 211, a source data selection facility 212, a knowledge base development facility 213, a knowledge base search development facility 214, a prompt construction facility 215, a generative model development facility 216, a hyperparameter tuning facility 217, and/or any other suitable facility for selecting, constructing, or configuring components of a RAG-based generative AI system. The AI system construction facility 210 can include all of the facilities 211-217 illustrated in FIG. 2A, or any suitable set of one or more of the facilities 211-217. Brief descriptions of some embodiments of the facilities 211-217 are provided below. More detailed descriptions of the implementations or capabilities of some embodiments of the facilities 211-217 are provided herein.

In some embodiments, the user interface facility 211 is configured to provide a user interface for the AI system construction facility 210. The user interface may be configured to receive user input relating to the construction of one or more AI systems. For example, with respect to the construction of one or more RAG-based generative AI systems, the user interface may be configured to receive user input relating to the selection of source data for a knowledge base 130, construction and configuration of the knowledge base 130, configuration of a knowledge base search facility 125, configuration of a prompt construction facility 120, selection and configuration of a generative model 140, etc. In some embodiments, the user interface may be configured to receive user input specifying parameter values and/or hyperparameter values relating to the configuration or construction of the knowledge base 130, knowledge base search facility 125, prompt construction facility 120, and/or generative model 140 of one or more RAG-based generative AI systems. In some embodiments, the user interface may be configured to provide output (e.g., a dashboard) relating to the development and/or performance of the constructed RAG-based generative AI systems.

In some embodiments, the source data selection facility 212 is configured to select a corpus of source information (e.g., a document corpus, a data corpus, etc.), and to provide source data for a knowledge base 130 based on the selected corpus of source information. In some examples, the source data selection facility 212 provides the selected corpus of source information as the source data, without pre-processing or filtering the corpus of source information. In some examples, the source data selection facility 212 filters the corpus of source information (e.g., identifies a subset of the corpus of source information that satisfies criteria specified by a user), and provides the filtered source information as the source data. For example, the source data selection facility can perform time filtering on the corpus of source information, such that information corresponding to a specified date/time range is included in the source data, and information not corresponding to the specified date/time range is excluded from the source data. Any suitable technique can be used to determine whether source information “corresponds” or does not correspond to a date/time range. For example, units of the source information may be timestamped, such that units of source information having timestamps within the specified date/time range are included in the source data, and units of source information having timestamps outside the specified date/time range are excluded from the source data. In some examples, the timestamp associated with a source of information may be a date/time when the information was obtained (e.g., received, measured, etc.) or published.

In some embodiments, the knowledge base (KB) development facility 213 is configured to construct knowledge bases (KBs) representing the source data provided by the source data selection facility 212. In some examples, the KB development facility 213 divides the source data into “chunks” (units of data), encodes each of the chunks (e.g., as a vector embedded in the embedding space of the knowledge base), and constructs a knowledge base 130 containing the embeddings. Parameters (or hyperparameters) of the knowledge base construction process can include the technique used to divide the source data into chunks (e.g., “chunking approach”), the chunk size (e.g., maximum number of tokens per chunk), and the chunk overlap percentage (e.g., the extent to which the information included in one chunk can also be included in another chunk). Likewise, parameters (or hyperparameters) of the knowledge base construction process include the encoder model or encoding technique used to generate the vector embeddings corresponding to each chunk of source data. Some non-limiting examples of suitable encoder models or encoding techniques include BERT, RoBERTa, GPT (e.g., GPT-3.5, GPT-4, GPT-4 Turbo, GPT-4o, GPT-4o mini, etc.), XLNet, Claud, etc.

In some examples, the KB development facility also creates metadata (or a lookup table, or a database) associating each embedding with the chunk of source data represented by the embedding. When the knowledge base is used to provide context for prompts, the metadata (or lookup table, or database) can be used to retrieve the source data corresponding to an embedding.

In some embodiments, the knowledge base (KB) search development facility 214 configures the knowledge base search facility 125 of a generative AI system. Parameters (or hyperparameters) of the KB search facility configuration process can include the similarity assessment technique used by the KB search facility 125 to assess the similarity between two embeddings. Some non-limiting examples of suitable similarity assessment techniques are described below.

In some examples, a vector embedding representing a data object (e.g., chunk of source data, query, prompt, completion, etc.) in the embedding space of the KB “matches” another vector embedding if the two embedding satisfy one or more matching criteria. In some examples, satisfaction of the matching criteria by two embeddings indicates that the embeddings are sufficiently similar or sufficiently proximate to each other in the embedding space, such as by being up to (e.g., less than or equal to) a threshold distance from one another in an embedding space. When the embeddings encode data objects, satisfaction of the matching criteria by two embeddings can imply that the data objects represented by those embeddings are semantically similar (e.g., relate to the same topic).

Any suitable matching criteria can be used to assess whether vector embeddings match, and any suitable techniques can be used to determine whether vector embeddings satisfy matching criteria, as embodiments are not limited in this respect. For example, a vector similarity metric (e.g., Euclidean distance, Manhattan distance, Minkowski distance, Chebychev distance, L2-squared distance, cosine similarity, dot product similarity, etc.) can be applied to two vector embeddings to assess their similarity. In some examples, a matching criterion may be satisfied if the value of the vector similarity metric is within a range (e.g., the Euclidean, Manhattan, Minkowski, Chebychev, or L2-squared distance between the vectors is less than a threshold distance; the difference between ‘1’ and the cosine similarity value for the vectors is less than a threshold value, the dot product of the vectors is greater than a threshold value, etc.). As another example, a nearest neighbor algorithm (e.g., k-nearest neighbors, approximate nearest neighbors (ANN), etc.) can be applied to an embedding to identify one or more embeddings that are neighbors of the molecule embedding in the vector database's embedding space. In some examples, with respect to a query embedding, a matching criterion is satisfied for any embeddings that are identified by the nearest neighbor algorithm as being neighbors of the query embedding.

In some embodiments, a prompt construction development facility 215 configures the prompt construction facility 120 of a generative AI system. Parameters (or hyperparameters) of the prompt construction facility configuration process can determine the prompt generation technique used by the prompt construction facility 120, the context selection technique used by the prompt construction facility 120 (e.g., the technique used to select the context inserted into a constructed prompt from the data retrieved from the knowledge base), the prompt template(s) used by the prompt construction facility 120 to construct prompts, etc.

In some embodiments, a generative model development facility 216 configures the generative model 140 of a generative AI system. Parameters (or hyperparameters) of the generative model configuration process can determine which type of generative model is used, whether the generative model is fine-tuned, what data are used to fine-tune the selected generative model, etc.

In some embodiments, a hyperparameter tuning facility 217 recommends or selects values for one or more of the parameters or hyperparameters of the processes performed by the AI system construction facility 210. In some embodiments, the hyperparameter tuning facility 217 is configured to automatically construct generative AI systems using different combinations of hyperparameter values.

The AI system assessment facility 230 can include a user interface facility 231, a qualitative assessment facility 232, a quantitative assessment facility 233, a synthetic evaluation data facility 234, a word impact facility 235, an auditing facility 236, a prompt assessment facility 237, and/or any other suitable facility for monitoring components of a RAG-based generative AI system. The AI system assessment facility 230 can include all of the facilities 231-237 illustrated in FIG. 2A, or any suitable set of one or more of the facilities 231-237. Brief descriptions of some embodiments of the facilities 231-237 are provided below. More detailed descriptions of the implementations or capabilities of some embodiments of the facilities 231-237 are provided herein.

In some embodiments, the user interface facility 231 is configured to provide a user interface for the AI system assessment facility 230. The user interface may be configured to receive user input relating to the monitoring of one or more AI systems. In some embodiments, the user interface may be configured to provide output (e.g., a dashboard) relating to the monitoring of the RAG-based generative AI systems. In some embodiments, the user interface facility 231 may provide a visualization of a knowledge base's embedding space, a visualization of word impact scores, or any other suitable visualization. In some embodiments, the user interface facility may provide assessments of the monitored generative AI systems.

In some embodiments, the qualitative assessment facility 232 provides qualitative assessments of the monitored AI systems, their components, or their completions. In some embodiments, qualitative assessments include topic analysis. For example, the qualitative assessment facility 232 may identify topics present (or missing) in the knowledge base of a monitored AI system. In some examples, the qualitative assessment facility can use a generative model to generate a summary of the information in a topic cluster. In some embodiments, the qualitative assessment facility can identify outliers present in a knowledge base, portions of the embedding space that are sparsely populated; proprietary/non-public documents inadvertently included in the knowledge base, etc. In some embodiments, the qualitative assessment facility can identify clusters in a knowledge base having topics that match the topic of a query, prompt, or completion.

In some embodiments, the quantitative assessment facility 233 provides quantitative assessments of the monitored AI systems (or components thereof). In some embodiments, the quantitative assessment facility 233 obtains these quantitative assessments by providing synthetic evaluation data as input to the monitored AI systems (or their components) and evaluating the completions generated by the monitored AI systems in response to that input.

In some embodiments, the synthetic evaluation data facility 234 generates synthetic evaluation data (e.g., synthetic user inputs) that can be used to quantitatively assess one or more monitored AI systems.

In some embodiments, the word impact facility 235 assesses the word impact of words in queries (e.g., user inputs provided to monitored AI systems or prompts provided to the generative models of such systems). In some examples, word impact scores quantify the extent to which individual words or phrases in a query cause the query to match the portions of the knowledge base that are used to produce a completion.

In some embodiments, the auditing facility 236 audits the completions generated by a monitored AI systems (e.g., identifies the embeddings in the knowledge base that are used to produce a completion, or the portions of the source data represented by those embeddings).

In some embodiments, the prompt assessment facility 237 assesses characteristics of prompts constructed by the monitored AI systems and/or provided to the generative models of the monitored AI systems. In some embodiments, the prompt assessment facility 237 provides feedback or guidance to users regarding revisions to queries.

Referring to FIG. 2B, an example of a method 250 for building and evaluating RAG-based AI systems is illustrated, according to some embodiments. The method 250 may be performed, for example, by an AI development system 200. At step 252, source data (e.g., a document corpus) is provided to the AI development system 200. At step 254, the KB development facility 213 creates multiple versions of a knowledge base (“candidate KBs”) based on the document corpus. Each version of the knowledge base may be generated using a different set of parameter values (e.g., hyperparameter values) for the knowledge base creation process. At step 256, the synthetic evaluation data facility 234 generates synthetic user inputs based on the content of the candidate KBs. Some non-limiting examples of techniques for generating synthetic evaluation data (e.g., user inputs) are disclosed herein. In some embodiments, the synthetic user inputs are generated by prompting a generative model (e.g., an LLM) to identify questions relevant to documents or information in the candidate KBs. At step 260, the AI system assessment facility 230 queries the candidate KBs using the synthetic user inputs (or constructed prompts derived from the synthetic user inputs), and the candidate KBs return embeddings matching the synthetic queries. The synthetic queries and the matching embeddings are then provided to a generative model, which uses the matching embeddings to generate completions responsive to the synthetic queries.

At step 262, the completions are assessed (e.g., scored) in accordance with one or more metrics (e.g., factualness/factual accuracy, faithfulness, grounded-ness, toxicity/appropriateness, correctness, topicality, etc.). The assessments (e.g., scores) may be assigned manually (e.g., by human assessors) or automatically (e.g., by the AI system assessment facility 230 or a component thereof, e.g., the quantitative assessment facility 233). In some embodiments, at least one of the metrics may indicate whether the KB candidate returned the document(s) from which the synthetic user input was generated. At step 264, the AI system assessment facility 230 or a component thereof ranks the KB candidates based on the assessments of the individual completions derived from the respective KB candidates' embeddings. The AI system assessment facility 230 may use such rankings to recommend one or more high-performing KB candidates (e.g., the highest-performing KB candidate) to the user.

At step 265, the qualitative assessment facility 232 performs topic analysis on each of the candidate KBs, and generates metadata indicating the topic(s) represented by or associated with individual embeddings or sets of embeddings in each candidate KB. In some embodiments, the topic analysis performed at step 265 may be performed by an LLM (e.g., an LLM prompted to identify the topic to which a chunk of data (e.g., a document, set of documents, portion of a document, data chunk corresponding to a vector embedding, user input, constructed prompt, completion, etc.) relates. At step 266, the quantitative assessment facility 233 determines a topicality score for each synthetic user input (or the corresponding constructed prompt) and the corresponding completion. The topicality score indicates the extent to which the topic of the completion matches the topic of the user input (or constructed prompt). Some non-limiting examples of techniques for determining the topicality score for a completion are described herein. At step 268, the word impact facility 235 generates similarity match explanations for the user input (or constructed prompt)/completion pairs. The similarity match explanation may indicate which words in the synthetic input influenced the candidate KB to return on-topic information (and the strength of that influence), and which words in the synthetic input influenced the candidate KB to return off-topic information (and the strength of that influence). Similarity match explanations may be generated based on word impact assessments, as described in more detail herein.

In some embodiments, the KB construction method 250 may be used to build and evaluate multiple KB candidates for a Gen AI system. In some embodiments, the KB candidates may be augmented with analytics identifying topics represented by embeddings (or sets of embeddings), outliers in the embedding space, etc.

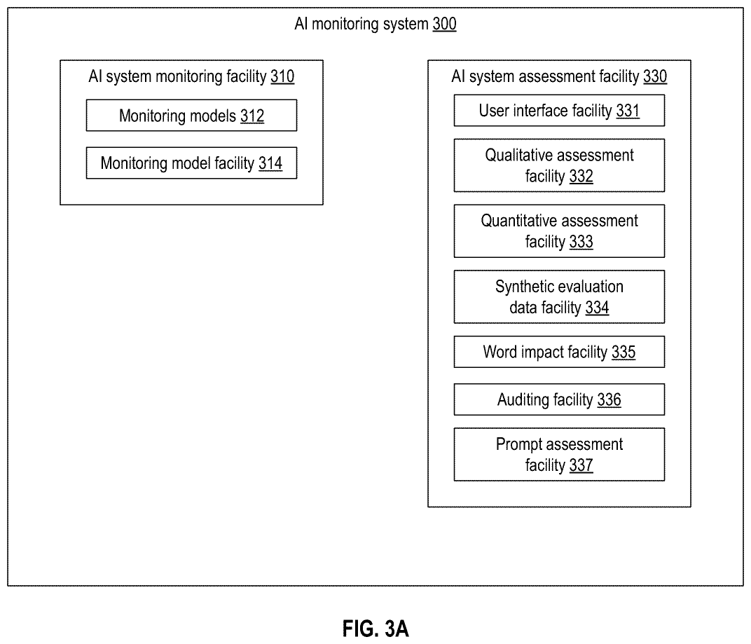

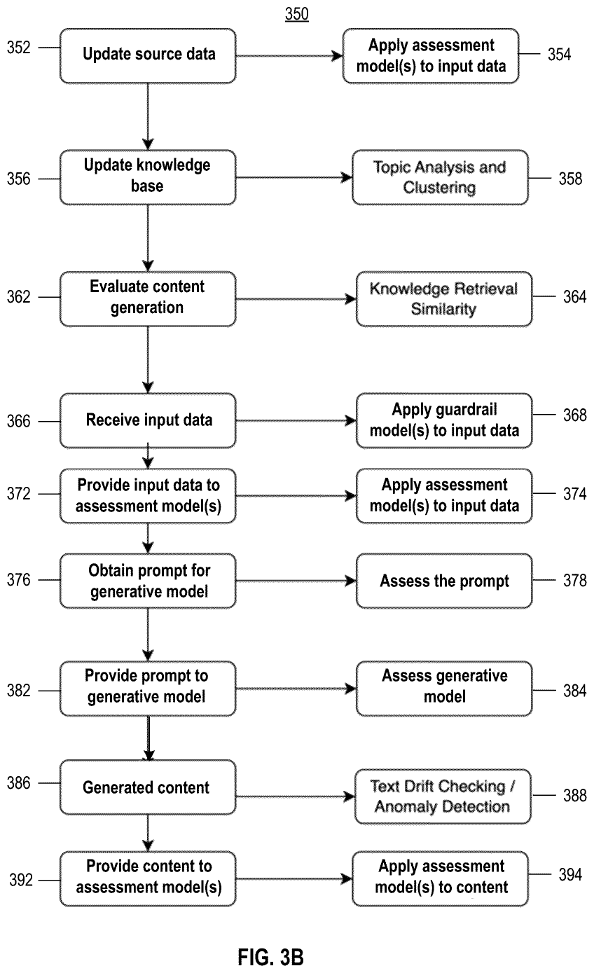

FIG. 3A shows a block diagram an AI monitoring system 300, according to some embodiments. The AI monitoring system 300 provides facilities for monitoring a generative AI system, inputs to the monitored system, outputs from the monitored system, and/or components of the monitored system. In some embodiments, the AI monitoring system includes an AI system monitoring facility 310 and an AI system assessment facility 330. In some embodiments, the AI system monitoring facility 310 includes one or more monitoring models 312 and a monitoring model facility 314. The one or more monitoring models 312 can include assessment models, guardrail models, and/or any other suitable models. Monitoring models can include predictive models and/or generative models. In some embodiments, the monitoring model facility 314 uses one or more of the monitoring models to provide monitoring techniques (e.g., moderation, assessment, reporting, etc.). More detailed descriptions of monitoring models and monitoring techniques are provided herein.

In some embodiments, the AI system assessment facility 330 includes facilities for assessing a generative AI system (e.g., a RAG-based generative AI system). Assessing a generative AI system can include monitoring and/or explaining the operation of a generative AI system. The AI system assessment facility 230 can include a user interface facility 331, a qualitative assessment facility 332, a quantitative assessment facility 433, a synthetic evaluation data facility 334, a word impact facility 335, an auditing facility 336, a prompt assessment facility 337, and/or any other suitable facility for monitoring components of a RAG-based generative AI system. The AI system assessment facility 330 can include all of the facilities 331-337 illustrated in FIG. 3A, or any suitable set of one or more of the facilities 331-337.

FIG. 3B shows an example of a method 350 for monitoring a RAG-based AI system, according to some embodiments. The method 350 may be performed, for example, by an AI monitoring system 300. At step 352, the source data (e.g., document corpus) of the monitored AI system may be updated (e.g., documents may be added to or removed from the document corpus, documents within the document corpus may be revised, etc.). If the source data are updated, an assessment model (e.g., a monitoring model 312 trained to detect drift and/or anomalies in a dataset) can monitor 354 metrics associated with the monitored AI system's source data (e.g., document corpus) for drift or anomalies. In some embodiments, the assessment model monitors the raw source data (e.g., the raw text of the document corpus) for drift or anomalies. Some non-limiting examples of techniques for using assessment models to detect drift or anomalies in the source data of an AI application are described herein.

At step 356, the knowledge base of the monitored AI system may be updated (e.g., based on the updates to the source data). If the knowledge base is updated, qualitative assessment facility 332 can apply topic analysis 358 to the updated knowledge base to identify topics represented in the knowledge base. In some embodiments, the qualitative assessment facility performs the topic analysis by clustering the knowledge base's embeddings and analyzing the topics of the clusters. Some non-limiting examples of techniques for performing topic analysis are described herein.

At steps 362-364, the AI system assessment facility 330 can evaluate the generation of content (e.g., completions) by the monitored AI system based on the information contained in the knowledge base. In some embodiments, the assessment facility 330 uses an evaluation dataset to evaluate the monitored AI system's generation of content. Some non-limiting embodiments of techniques for generating synthetic evaluation data and for using evaluation data (synthetic or otherwise) to evaluate the monitored AI system's retrieval of information from its knowledge base are described herein. In some embodiments, the evaluation data may include validation tuples. Each validation tuple may include a query (e.g., user input or constructed prompt) and an expected response to the query. In some embodiments, the evaluation process may involve the assessment facility 330 submitting the validation queries to the monitored AI system and assessing the similarity between the expected response to a query and the completion actually generated by the AI system's generative model 140. The similarity between the expected response to a query and the corresponding completion provided by the AI system's generative model may be scored (e.g., by quantitative assessment facility 333) to assess the quality of the AI system's knowledge retrieval and text generation functionality. Some non-limiting examples of techniques for evaluating an AI system's content generation are/or scoring an AI system's completions are described herein.

At step 366, the monitored AI system receives input data (e.g., user input). The input data may be provided in any suitable form, e.g., as a query or a prompt. At step 368, the one or more guardrail models (e.g., monitoring models 312 trained to detect violation of guardrail conditions) can analyze the input data to determine whether it violates a system guardrail. For example, a PII (personally identifiable information) guardrail model may detect PII in the input data, and the AI monitoring system 300 may initiate remedial action based on the detection of the PII. For example, the AI monitoring system 300 may reject the input data, remove the PII from the input data before providing the input data to a prompt construction facility 120 or to the generative model 140, and/or may alert the user that the input data contains PII. As another example, a toxicity guardrail model may detect toxic content in the input data, and the AI monitoring system 300 may initiate remedial action based on the detection of the toxic content. For example, the AI monitoring system 300 may reject the input data, remove the toxic content from the input data before providing the input data to a prompt construction facility 120 or to the generative model 140, and/or alert the user that the input data contains toxic content.

More generally, the AI system monitoring facility 310 can use one or more guardrail models at step 366 to detect undesirable input data (e.g., queries) before those queries are submitted to the prompt construction facility 120 or the generative model 140, thereby preventing the monitored AI system from wasting valuable processing resources on bad queries and preventing users from manipulating the monitored AI system's generative model 140 into carrying out nefarious tasks. For example, a prompt injection guardrail model (e.g., a monitoring model 312 trained to detect prompt injection) can detect queries designed using prompt injection principles, and the AI monitoring system 300 can reject such queries rather than submitting them to the prompt construction facility 120 or the generative model 140. Likewise, a topicality guardrail model (e.g., a monitoring model 312 trained to determine the topic of a query) can detect queries relating to topics not supported by the monitored AI application (e.g., outside the scope of the knowledge base or outside the scope of the intended use of the monitored AI application), and the AI monitoring system 300 can reject such queries rather than submitting them to the prompt construction facility 120 or generative model 140, thereby avoiding or limiting scenarios in which the monitored AI system provides erroneous and/or hallucinatory output. In some examples, a sentiment guardrail model (e.g., a monitoring model 312 trained to determine the sentiment of a query) can classify the sentiment of the query (e.g., as “positive” or “negative”), and the AI monitoring system 300 can reject queries that are classified as having unwanted types of sentiment. In some examples, an anomaly guardrail model (e.g., a monitoring model 312 trained to detect anomalies) can detect one or more anomalies in the input data, and the AI monitoring system 300 can initiate remedial action based on the detection of the anomaly. For example, the AI monitoring system 300 can reject the input data, remove the anomalous content from the input data before providing the input data to a prompt construction facility 120 or to the generative model 140, and/or alert the user that the input data contains an anomaly.

At step 372, input data not rejected by the AI monitoring system 300 may be provided as input to one or more assessment models (e.g., monitoring models trained to provide assessments of input data), which may assess attributes of the input data. In some examples, the assessment model may predict behaviors or infer attributes of the user. At step 374, the outputs of the assessment model(s)(e.g., metrics measured by the assessment model(s), values determined by the assessment model(s), classifications assigned by the assessment model(s), etc.) may be tracked (e.g., stored) internally by the AI monitoring system and/or reported to a user (e.g., via the user interface facility 331).

At step 376, the monitored AI system obtains a prompt for the generative model. In some examples, the input data received at step 366 (including any revisions applied to the input data in response to the outputs of the various monitoring models) is the prompt. In some examples, the prompt construction facility 120 of the monitored AI system constructs the prompt based on original or revised input data. In some examples, the constructed prompt 135 includes the original or revised input data and additional content. In some examples, the additional content includes the content (e.g., text) of a prompt template. In some examples, the additional content includes information (e.g., “context”) retrieved from the knowledge base. The prompt construction facility 120 can construct the prompt 135 based on the input data (original or revised), the knowledge base, and/or on the outputs of the monitoring models (e.g., anomaly detection model(s), guardrail model(s), assessment model(s), etc.). In some examples, the prompt construction facility 120 customizes the constructed prompt to the user.

At step 378, the prompt assessment facility 337 can assess the prompt (e.g., determine attribute(s) of the prompt, determine values of metrics associated with the prompt, monitor the prompt for drift or anomalies, etc.). In some embodiments, the prompt assessment facility 337 assesses the raw text of the prompt. In some examples, the prompt assessment facility 337 counts the number of tokens in the prompt and/or assesses (e.g., estimates) the cost of processing the prompt with the generative model 140. In some examples, the prompt assessment facility 337 determines how many of these tokens derive from information retrieved from the knowledge base, reports citations for the information derived from the knowledge base, and/or performs any other suitable monitoring actions.

At step 382, the AI monitoring system 300 provides the prompt 135 to the monitored AI system's generative model 140, which generates content 386 (e.g., a completion, a text completion, etc.) in response to the prompt. At step 384, the AI monitoring system 300 assesses the operation of the monitored AI system's generative model. In some examples, the AI monitoring systems uses one or more assessment models to measure one or more performance metrics associated with the operation of the generative model. Some non-limiting examples of performance metrics may include latency (e.g., the time taken to generate the response), completion token count (the number of tokens in the response), financial cost for generating the completion, etc.

At step 388, the AI system monitoring facility 310 can use one or more guardrail models determine whether the content generated by the monitored AI system violates a system guardrail. Some non-limiting examples of guardrail models that may be applied to the generated content include a PII detection model, a sentiment classifier, a topicality model, and a toxicity model. Any suitable action may be taken based on the output of a guardrail model. For example, if any of the guardrail models indicates that the generated content contains unwanted content (e.g., PII, content classified as having an unwanted sentiment, off-topic content, or toxic content), the AI system monitoring facility 310 can remove unwanted content from the generated content or suppress the generated content. In this way, the AI monitoring system 300 can prevent or limit the dissemination of harmful or untrue information by the monitored AI system. The AI monitoring system 300 can additionally or alternatively provide a variety of other preconfigured and/or user-configured guardrail models.

At step 392, the AI monitoring system 300 can provide the generated content (e.g., in original form or after removing unwanted content) as input to one or more assessment models (e.g., monitoring models trained to assess generated content). At step 394, the assessment model(s) may assess attribute(s) of the generated content (e.g., grounded-ness, faithfulness, correctness, etc.). The AI monitoring system 300 can metrics associated with the predictive model that monitors the generative output may be tracked (e.g., stored) internally by the AI monitoring system and/or reported to a user (e.g., via the user interface facility 331).

Some Embodiments of AI System Monitoring and/or Assessment Techniques

### Some Embodiments of Techniques for Generating Synthetic Evaluation Data

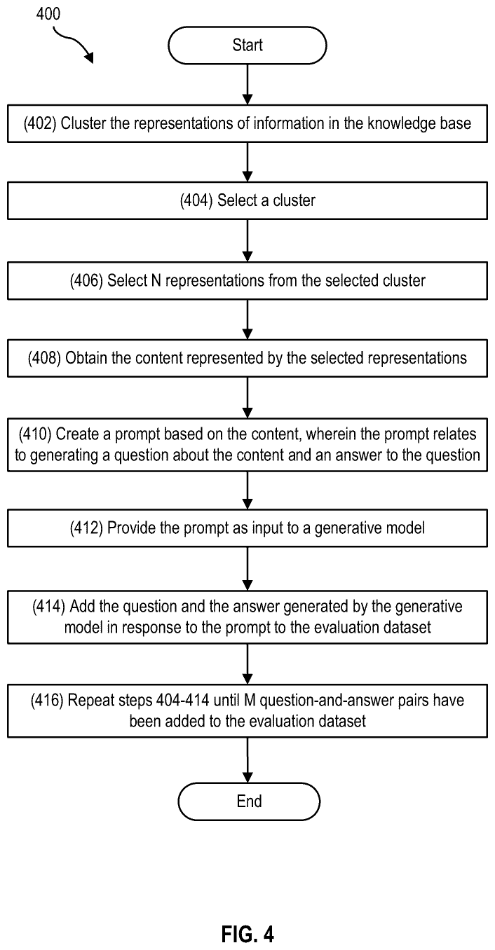

FIG. 4 is flowchart of a method 400 for generating a synthetic evaluation dataset, according to some embodiments. As described above, an evaluation dataset can be used to evaluate the performance of generative AI systems (e.g., by comparing an AI system's performance to its own performance at another time, or to the performance of other generative AI system). Likewise, an evaluation dataset can be used to evaluate the performance of blueprints for constructing generative AI systems (e.g., by comparing the performance of generative AI systems or generative models constructed using the blueprints).

At step 402, the representations (e.g., embeddings) of information (e.g., chunks of source data) in the knowledge base of the generative AI system are clustered, thereby producing a set of clusters. For example, the knowledge base may be a vector database of vector embeddings representing information, and the embeddings may be clustered. The clustering can be performed using any suitable clustering technique, and can be based on semantic similarity between the representations (e.g., cosine similarity between the embeddings) or distance between the embeddings in the embedding space. Some non-limiting examples of techniques for determining semantic similarity or distance between pairs of embeddings in an embedding space are described herein.

At step 404, a cluster is selected from the set of clusters. The cluster can be selected using any suitable technique. For example, the cluster can be selected randomly (with or without replacement) from the set of clusters. In some examples, the cluster is selected randomly from a subset of the clusters, where the subset consists of clusters that have already been selected fewer than a threshold number of times. In some examples, the likelihood of a cluster being selected is based on the proportion of the knowledge base's representations assigned to the cluster. For example, the likelihood of selecting a larger cluster may be greater than the likelihood of selecting a smaller cluster, or vice versa.

At step 406, a sample of N representations (e.g., embeddings) is selected from the representations assigned to the selected cluster. The N representations can be selected using any suitable technique. In some examples, the N representations are randomly selected. In some examples, the N representations are selected from a subset of representations within a threshold distance of the center of the cluster. In some examples, the N representations nearest to the center of the cluster are selected.

At step 408, the content (e.g., chunks of source data, blocks of text, etc.) represented by the N selected representations is obtained from the knowledge base.

At step 410, a prompt is created based on a prompt template and the obtained content. In some examples, the prompt includes the obtained content and assigns the obtained content a label (e.g., “context”). In some examples, the prompt includes text suitable for prompting a generative model to generate a question about the context and an answer to the question. In some examples, the prompt includes text suitable for prompting a generative model to respond as a professor creating a test for advanced university students. In some examples, the prompt includes text suitable for prompting a generative model to provide its response as a Python dictionary with two keys (question and answer). In some examples, the prompt includes text suitable for prompting a generative model to provide the question and answer in a specified language using polite language.

At step 412, the prompt is provided as input to a generative model (e.g., the generative model 140 of the generative AI system 100 to be evaluated using the evaluation dataset).

At step 414, the question-and-answer pair generated by the generative model in response to the prompt is added to the evaluation dataset.

At step 416, steps 404-414 may be repeated until any suitable number M of question-and-answer pairs have been added to the evaluation dataset. In some examples, M is the number of clusters or less than the number of clusters. In some examples, the number of question-and-answer pairs is user-specified.

### Some Embodiments of Techniques for Quantitative Assessment of an AI System

In some embodiments, an AI system assessment facility (230, 330) or a component thereof (e.g., quantitative assessment facility, etc.) can monitor the operation of an AI system (e.g., a RAG-based generative AI system) and quantitatively assess one or more aspects of the system's operation. In some examples, a quantitative assessment may relate to the value of a semantic metric, which may relate to the semantics of the content (e.g., completion) generated by the AI system. Some non-limiting examples of semantic metrics can include topicality, factualness/factual accuracy, faithfulness, grounded-ness, toxicity (which may be the inverse of appropriateness), correctness, risk of disclosing personally identifiable information (PII), etc. In some examples, a quantitative assessment may relate to the value of an objective performance metric, which may be unrelated to the semantics of the content generated by the AI system. Some non-limiting examples of objective performance metrics can include the latency with which the AI system performs an operation, the AI system's content generation throughput, the number of tokens included in a data object handled by the AI system (e.g., a query, a prompt, a completion, etc.), the cost (in terms of monetary resources expended or computational resources used) to obtain generated content from the AI system, etc. In some examples, a quantitative assessment may relate to the detection of drift and/or anomalies in a set of data objects associated with the AI system (e.g., queries, context data, prompts, generated content, etc.).

In general, the quantitative assessment facility 233 of an AI development system 200 can monitor the operation of an AI system providing queries or prompts of an evaluation dataset (e.g., synthetic evaluation dataset) as input to the AI system (or components thereof) and evaluating the operation of the AI system in response to those queries or prompts. In general, the quantitative assessment facility 333 of an AI monitoring system 300 can monitor the operation of an AI system in response to queries or prompts of an evaluation dataset, or in response to actual user inputs provided to the deployed AI system.

The value of a topicality metric (e.g., a topicality score) can indicate the extent to which the topic of a completion matches the topic of a query (e.g., user input) or a constructed prompt. In some embodiments, the topicality score is determined by identifying the embeddings in the knowledge base matching the query (or prompt) and the embeddings matching the completion, and calculating the topicality score based on the similarity (e.g., distance) between those embeddings, such that the topicality score for two embeddings increases as the similarity between the embeddings increases (e.g., the distance between the embeddings in the embedding space decreases).

The value of a grounded-ness metric can indicate the extent to which the content (e.g., completion) generated by an AI system is based on the context data extracted from the knowledge base rather than being created internally within the generative model (e.g., derived from the generative model's training data or hallucinated by the generative model). In some embodiments, a quantitative assessment facility can monitor (e.g., determine and/or track) values of a grounded-ness confidence metric related to content generated by a generative model. For example, the quantitative assessment facility can calculate the value of a similarity metric indicating the extent of similarity between content generated by the generative model in response to a constructed prompt and chunks of source data from which the prompt construction facility derived the context data included in the constructed prompt. The quantitative assessment facility can calculate a confidence score for the content generated by the generative model based on the value of the similarity metric. These grounded-ness confidence scores can be monitored individually or in aggregate (e.g., as a numeric average). In some examples, grounded-ness confidence scores are based on ROUGE (Recall-Oriented Understudy for Gisting) scores or ROUGE-1 scores.

During development or monitoring or an AI system, the AI system assessment facility can evaluate how effectively the generative AI system uses the data retrieved from the knowledge base based on grounded-ness confidence scores. For example, the AI system assessment facility can determine whether the prompt construction facility 120 of a generative AI system is integrating the retrieved data into the prompt provided to the generative model in a suitable manner and/or determine whether the generative model is processing the provided context data in a suitable manner based on grounded-ness confidence scores. If the grounded-ness confidence score for a particular completion generated by an AI system is less than a threshold value, the AI system assessment facility may alert the user that confidence in the grounded-ness of the completion is low. If the average grounded-ness confidence score for completions generated by an AI system is less than a threshold value, the AI system assessment facility may alert the developer or operator of the AI system that confidence in the grounded-ness of the system's completions is low.

In some examples, a quantitative assessment facility can monitor (e.g., determine and/or track) a faithfulness score (e.g., a value of a faithfulness metric) based on content generated by a generative AI system. In these examples, “faithfulness” corresponds to a measure of whether the content generated by the generative AI system includes hallucinated information or not. In some examples, faithfulness can be scored using a Llama index (e.g., the “Faithfulness Evaluator” Llama index). In some embodiments, faithfulness can be scored as a binary value (e.g., the generated content was either faithful or hallucinated) and/or as a numeric value (e.g., a probability that the generated content was hallucinatory). If the faithfulness score for a particular completion generated by an AI system is less than a threshold value, the AI system assessment facility may alert the user that confidence in the faithfulness of the completion is low. If the average faithfulness score for completions generated by an AI system is less than a threshold value, the AI system assessment facility may alert the developer or operator of the AI system that confidence in the faithfulness of the system's completions is low.

The value of a factualness (or factual accuracy) metric can indicate the extent to which the content (e.g., completion) generated by an AI system is consistent with the content of trusted, factual sources of information. In some embodiments, a quantitative assessment facility can monitor (e.g., determine and/or track) values of a factual confidence metric related to content generated by a generative model. For example, the quantitative assessment facility can identify assertions (e.g., statements or implicit assumptions) of fact in a completion generated by the AI system, search for confirmation of the assertions and/or counter-examples to the assertions in the trusted, factual sources of information, and determine the value of the factual confidence metric for the completion based on the extent to which the assertions are confirmed or contradicted by the trusted, factual sources of information. These factual accuracy confidence values can be monitored individually or in aggregate (e.g., as a numeric average). If the factual accuracy confidence value for a particular completion generated by an AI system is less than a first threshold value (or greater than a second threshold value), the AI system assessment facility may alert the user that confidence in the factual accuracy of the completion is low (or high). If the average factual accuracy confidence value for completions generated by an AI system is less than a threshold value, the AI system assessment facility may alert the developer or operator of the AI system that confidence in the factual accuracy of the system's completions is low.

The value of an appropriateness (or toxicity) metric can indicate the extent to which the content (e.g., completion) generated by an AI system is appropriate or toxic (e.g., in terms of tone, vocabulary, language, subject matter, etc.). In some examples, a quantitative assessment facility includes a toxicity model (e.g., a monitoring model trained to identify toxic content in completions generated by an AI system. In these examples, a toxicity model can classify generated content according to toxicity, and the AI system assessment facility can apply moderation techniques to suppress the dissemination of toxic content.

In some embodiments, the value of a correctness metric can indicate the extent to which the content generated by an AI system is syntactically correct (e.g., text that conforms to the syntactic and grammatical rules of the language in the text is written, or source code that conforms to the syntactic rules of the programming language in which the code is written). In some embodiments, a quantitative assessment facility can determine the value of such a correctness metric for a completion by applying syntactic and/or grammatical rules to the completion. In some examples, the quantitative assessment facility can determine the value of such a correctness metric using a Llama library (e.g., the Llama Correctness Evaluator). Correctness can be scored as a numeric value and can be scored in aggregate as a numeric average.

In some embodiments, the value of a correctness metric can indicate the extent to which the content generated by an AI system matches the expected content. In some embodiments, a quantitative assessment facility can monitor (e.g., determine and/or track) a correctness score (e.g., a value of a correctness metric) indicating the correctness of the content generated by a generative AI system. In these embodiments, for the queries contained in an evaluation dataset, the quantitative assessment system can compare the content generated by the AI system to the expected content indicated by the evaluation dataset. Correctness can be scored as a numeric value and can be scored in aggregate as a numeric average. In some embodiments, correctness scores can be used to determine whether the combination of a particular knowledge base, prompt construction facility, and generative model produces the expected outputs specified in the evaluation dataset.

The value of a PII risk metric can indicate the risk that a data object processed by an AI system includes PII. In some examples, a quantitative assessment facility can monitor (e.g., determine and/or track) whether inputs, prompts, and/or completions include personally identifiable information (PII). In some examples, the quantitative assessment facility can determine a value of a PII risk metric based on the quantity, sensitivity, and/or other attributes of the detected PII. The quantitative assessment facility can use any suitable technique or resource to detect PII and score the PII risk of a data object, including detection libraries (e.g., the Presidio library). The value of the PII risk metric can be useful in determining whether a generative AI system is likely to inadvertently leak sensitive information that may be present in the source data of its knowledge base and/or in the generative model's training data. The values of PII risk metrics can be monitored individually (e.g., for individual prompts and completions) or in aggregate (e.g., as a numeric average across a set of prompts and completions).

The value of a latency metric can indicate the duration of the time period used by the AI system to perform an operation. In some examples, a quantitative assessment facility of an AI system assessment facility can monitor (e.g., determine and/or track) the latency of the monitored AI system's operations (e.g., content generation). In these examples, the quantitative assessment facility can calculate how much time elapses while the monitored AI system (or its generative model 140) processes an query (or prompt) and generates content in response to that query (or prompt). In some embodiments, this time may be measured from the time when query (e.g., user input) is provided to (or received by) the monitored AI system to the time when the monitored AI system provides generated content in response to that query. In some embodiments, this time may be measured from the time when a constructed prompt is provided to (or received by) the generative model 140 to the time when the generative model 140 provides generated content in response to that prompt. Additionally or alternatively, the quantitative assessment facility 333 can measure other components of latency, for example, a latency of the prompt construction operation, or latency of any operation or set of operations performed by the monitored AI system during the process of processing a query and/or generating a completion. Latency metrics may be useful for developing and/or monitoring generative AI systems used for time-sensitive applications such as applications that interact with users in real-time. In some embodiments, the values of a latency metric can be monitored individually or in aggregate. In some examples, aggregate latency can be determined and/or reported as a numeric average of the latency across all responses generated by the monitored AI system when processing an evaluation dataset.

In some embodiments, a quantitative assessment facility can monitor (e.g., determine and/or track) token counts. For example, the quantitative assessment facility can monitor the token counts of prompts constructed by the prompt construction facility 120 of an AI system or other prompt construction system. As an additional example, the quantitative assessment facility can monitor token counts of content (e.g., completions) generated by the generative model 140 of an AI system. In some embodiments, the quantitative assessment facility can monitor the number of tokens retrieved from a knowledge database (e.g., by a prompt construction facility 120) or from another source of grounding data. Additionally or alternatively, the quantitative assessment facility can monitor total token counts (e.g., for queries, retrieved context, constructed prompts, and/or generated content) across an entire completion generation process of the AI system. Token counts can be monitored individually or in aggregate (e.g., as a numeric average).

During AI system development, token count metrics for blueprints may be useful for selecting blueprints that produce generative AI systems that tend to generate concise completions (e.g., systems for which an expected token count for completions is less than a first threshold) or verbose completions (e.g., systems for which the expected token count for completions is greater than a second threshold). In some examples, the expected token count for the completions of a blueprint (or the generative AI system produced by a blueprint) can be the mean or median token count of all completions generated by the system in response to the prompts (or inputs) in an evaluation dataset. In some examples, expected token counts for generative models (e.g., third-party generative models that charge the user based on the number of tokens generated) can be used to manage costs related to the use of those generative models.

In further embodiments, a quantitative assessment facility can monitor (e.g., determine and/or track) a financial cost of generating content using a generative AI system. In some examples, the value of the cost metric can be determined using publicly available information provided by a host of a generative model used by a generative AI system. For example, this information can include a cost per input token, cost per output token, or other financial costs related to generating content using the hosted generative model. Financial costs can be scored as a numeric value in a currency (e.g., a dollar amount) and can be tracked in aggregate as a numeric average. In some examples, the values of cost metrics can be used to identify generative AI systems (or generative models) that satisfy one or more cost constraints (e.g., generate individual completions costing less than a threshold amount per completion, on average).

Some examples of techniques for performing drift detection and/or anomaly detection are described in U.S. Pat. No. 11,386,075, titled “Methods for detecting and interpreting data anomalies, and related systems and devices,” U.S. Patent Publication No. 2021/0390455, titled “Systems and methods for managing machine learning models,” and U.S. Patent Publication No. 2023/0196101, titled “Determining suitability of machine learning models for datasets,” each of which is hereby incorporated by reference herein in its entirety.

### Some Embodiments of Techniques for Developing an AI System

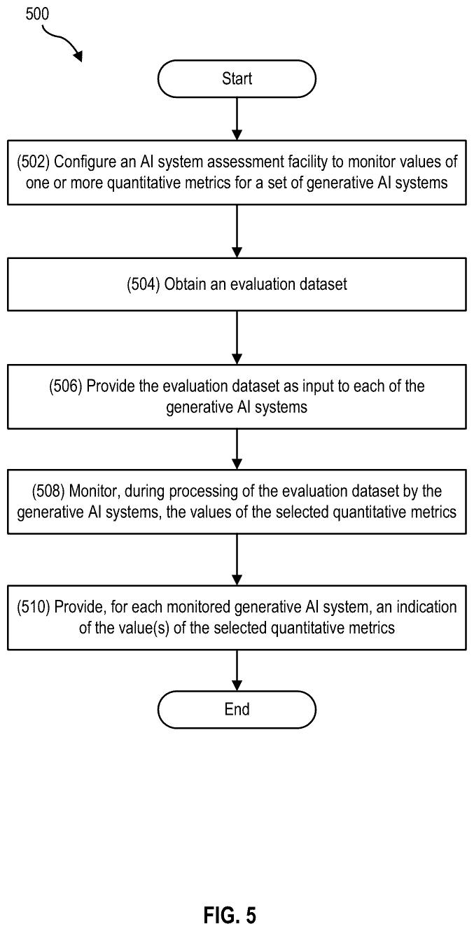

FIG. 5 is a flow diagram of an illustrative method 500 for monitoring values of metrics characterizing generative AI systems (or the blueprints used to build the generative AI systems), according to some embodiments. At step 502, an AI system assessment facility (230, 330) is configured to monitor values of one or more quantitative metrics for a collection of generative AI systems (e.g., produced by a collection of generative AI blueprints). These quantitative metrics may be selected from a larger group of quantitative metrics. For example, the AI system assessment facility may be capable of evaluating multiple generative AI systems (or blueprints) in parallel, and capable of monitoring the values of one or more of the quantitative metrics described herein.

At step 504, the AI system assessment facility may obtain an evaluation dataset. In some examples, the AI system assessment facility may retrieve an evaluation dataset from a repository of evaluation datasets. In some examples, a user may manually designate an evaluation dataset to use for the evaluation process. In some examples, the evaluation dataset contains synthetic evaluation data and/or is synthetically generated. Some examples of techniques for generating synthetic evaluation data are described herein.

At step 506, the AI system assessment facility may provide each query (or prompt) in the evaluation dataset to each AI system in the collection of AI systems. In other words, the AI system assessment facility may instruct each AI system to process the evaluation dataset.

At step 508 in FIG. 5, the AI system assessment facility may, during the processing of the evaluation dataset by the AI systems, monitor the values of the selected quantitative metrics.

At step 510, the AI system assessment facility may provide, for each evaluated AI system, an indication of the value(s) of each of the selected quantitative metrics. For example, the AI system assessment facility may provide (e.g., display) a table in which each row represents an AI system (or the blueprint used to produce the AI system) and each column represents an aggregate value of a monitored quantitative metric. In some examples, the AI system assessment facility may provide the results of the evaluation process for display via a user interface, such as in a graph, histogram, or other data visualization, to help users compare the AI systems (or blueprints).

### Some Embodiments of Techniques for Monitoring an AI System

In some embodiments, monitoring models (e.g., predictive models trained to monitor various aspects of an AI system's performance) are used to monitor the performance of an AI system's components. For example, monitoring models can be used to monitor (e.g., measure and/or track) and report the values of quantitative and/or qualitative metrics indicative of the performance of the system (or its components). In addition, drift detection models can be applied to the streams of metric values produced by the monitoring models over time.

In some examples, the outputs of the various monitoring models and/or the values of monitored metrics are tracked (e.g., stored, logged, aggregated, etc.) and/or analyzed by an AI system assessment facility (230, 330). The monitoring model outputs and/or the monitored metric values for individual inputs, prompts, and/or completions can be aggregated over many inputs, prompts, and/or completions to provide an estimate of the overall performance of the monitored AI system. For example, a monitored AI system that consistently produces completions with low confidence scores may benefit from reconfiguring the prompt construction facility 120 to retrieve context from the knowledge base that is more relevant to user inputs.

In some embodiments, an AI system assessment facility can use a variety of tools (e.g., facilities and/or models) to monitor values of a variety of metrics related to the performance of a monitored AI system. In some examples, values of metrics determined for individual inputs (e.g., user inputs, prompts, completions, etc.) can be aggregated across an evaluation dataset. An evaluation dataset can be tailored to test a wide range of a monitored AI system's capabilities, and can serve as an evaluation dataset for generative AI systems produced from a variety of blueprints, to facilitate comparison of various qualities of the generative AI systems produced by those blueprints. Based on such aggregated metric values, the blueprints or generative AI systems can be modified, fine-tuned, or otherwise updated to improve their performance. Aggregated metric values can also provide users with information suitable for making informed choices about which blueprint(s) are best suited for building a generative AI system for solving a particular problem.

In some examples, an AI system assessment facility can obtain aggregated metric values by providing an evaluation dataset to a monitored AI system. In these examples, the AI system assessment facility can obtain an evaluation dataset (e.g., from a database, from synthetic evaluation data facility 334, etc.). Such an evaluation dataset can include one or more sample prompts (e.g., user-provided or synthetic prompts) and, for each prompt, an expected output of the monitored AI system. The AI system assessment facility can then provide each sample prompt in the evaluation dataset to the monitored AI system and monitor that system's operation. In some examples, values of metrics can be determined in relation to the sample prompt, an output of an intermediate step (e.g., a constructed prompt), and/or the completion provided by the monitored AI system.

For a metric with binary values (e.g., a classification such as ‘toxic’ or ‘not toxic’), the aggregated metric value can be a binary percentage. For a metric with three or more potential values, the aggregate metric value can be a multiclass percentage. For a metric with numeric values, the aggregate metric can be an average. For a metric related to text content, the aggregate metric value can be any suitable measure of n-gram importance (e.g., unigram importance, TF/IDF vectorization, etc.).

In some embodiments, moderation tools can be used to provide guardrails that prevent or discourage users from attempting to use a generative AI system in unintended or unwanted ways. In some embodiments, one or more of the moderation tools may include a monitoring model. For example, if an AI system is intended to retrieve information or generate answers about a specific set of topics, a predictive model may be used to determine whether a query is related to one of the supported topics or to an unsupported topic. If the topicality model indicates that the query is related to an unsupported topic, the AI monitoring system may apply a “guardrail” by alerting the user that the query is not supported and preventing the generative model from processing the query. In this way, the AI monitoring system can provide a helpful error message to the user rather than the generative AI system generating a response that is untruthful, incorrect, hallucinatory, etc. Likewise, guardrails may be used to prevent the user from querying the generative AI system with malicious or toxic input. Other guardrails can include prompt injection detection tools (e.g., tools that detect inputs manipulated to overwrite or alter system prompts and/or templates in ways intended to cause the model to output unintended responses), sentiment classifiers (e.g., models that classify text sentiments within a set of categories, e.g., ‘positive’, ‘negative’, etc.), and/or toxicity detection tools (e.g., tools that prevent or limit dissemination of untrue or harmful information). In some embodiments, the AI monitoring system may allow users to provide custom moderation tools (e.g., guardrails incorporating user-provided predictive models) that allow AI system providers to further curate and/or moderate the AI system's inputs and/or outputs.

One advantage of inserting monitoring models into a monitored AI system at the component level (rather than simply monitoring inputs to the AI system and outputs from the AI system) is that the outputs of such models make it easier to determine which components are causing the monitored AI system to operate in unexpected or undesirable ways. In addition or in the alternative, when a monitoring model detects a potential problem (e.g., drift or an anomaly in a monitored input or output, an off-topic input, etc.), the AI monitoring system can alert the user to the presence of the issue, provide an explanation of the issue, and/or recommend remedial action (e.g., avoiding sensitive words in prompts, removing a portion of the knowledge base that is returning information of low relevance, etc.).

However, when monitoring models are used, it may be beneficial to update the monitoring models quickly and/or frequently (e.g., based on user feedback) as the AI system's components or the user-provided inputs change. In some embodiments, new training records can be automatically generated based on user feedback (e.g., the user's response to alerts or recommendations generated by the monitoring models), thereby augmenting the training datasets for the monitoring models. In this way, the monitoring models can be automatically retrained and redeployed based on the user's responses to the models' outputs.

Likewise, when monitoring models are used, it may be beneficial to update the monitored components (e.g., generative models, knowledge bases, prompt construction facilities, prompting templates, etc.) from time to time (e.g., based on user feedback and/or based on the outputs of the monitoring models). In some embodiments, new training records can be automatically generated based on user feedback or based on the outputs of the monitoring models, thereby augmenting the training datasets for the monitored components. In this way, the monitored components can be automatically retrained and redeployed based on the user feedback and/or the outputs of the monitoring models. In some embodiments, the automatic retraining and redeployment is carried out by the AI monitoring system.

Updating system components of an AI system or monitoring models of an AI monitoring system in place, without interfering with the AI system being monitored, can be difficult. In some embodiments, in situ evaluation of candidate AI system components and monitoring models can reduce or minimize disruption for users, while enabling the AI system and/or AI monitoring system to quickly adapt to changes. For example, candidate components and/or models can be deployed in parallel with existing components and/or models, in a shadow configuration, such that the outputs of the candidates components and/or models are monitored but are not provided to the user until their performance has been validated and/or their use has been authorized by the user.

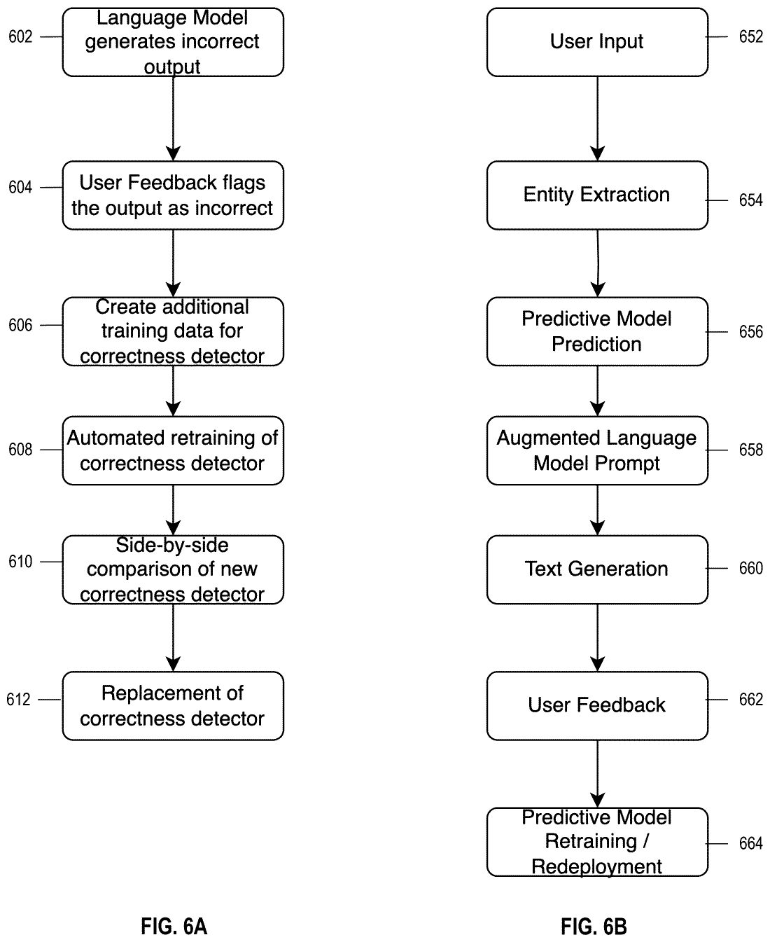

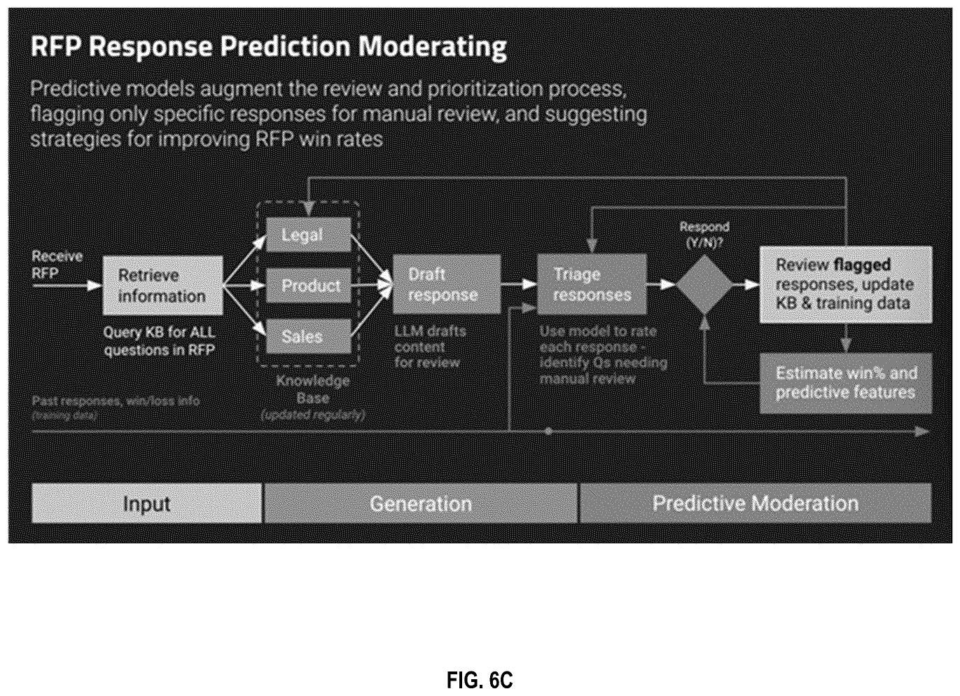

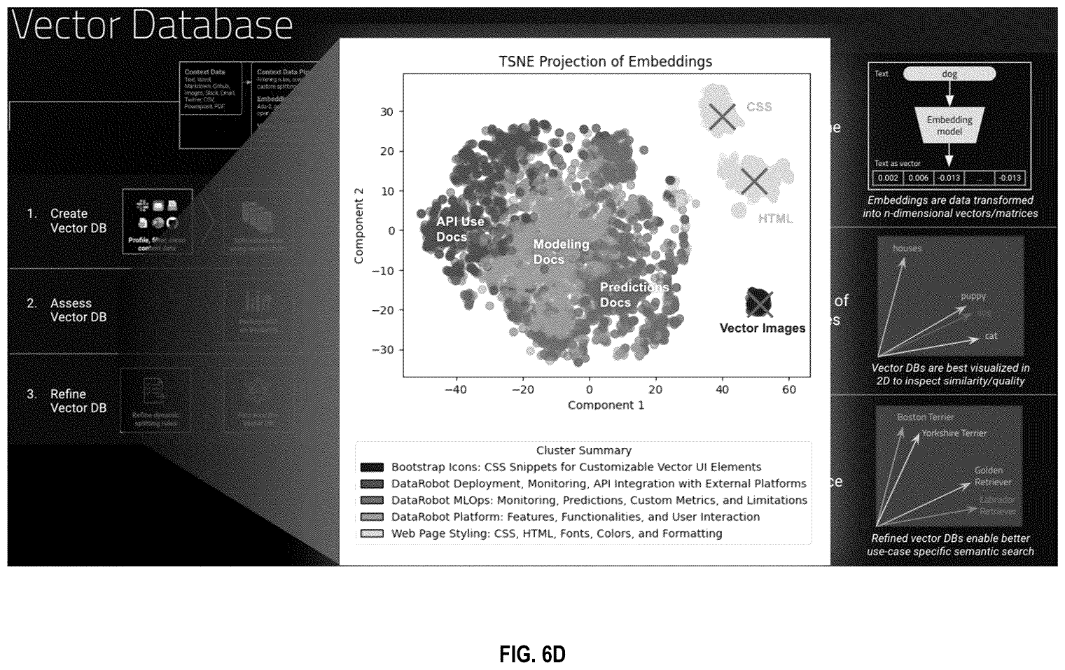

FIG. 6A shows an example of a method 600 for updating (e.g., adapting) a monitoring model (e.g., a correctness monitoring model) of an AI monitoring system 300, according to some embodiments. At step 602, the generative AI system generates an incorrect completion. At step 604, the user flags the completion as incorrect. At step 606, the AI monitoring system generates additional training data for the correctness monitoring model based on the user's feedback. At step 608, the correctness monitoring model is retrained using the new training data to improve the model's accuracy and/or precision at evaluating the correctness of completions generated by the generative AI system. At step 610, the retrained correctness monitoring model is compared to the existing correctness monitoring model via shadow execution. In some examples, the retrained correctness monitoring model is evaluated automatically by the AI monitoring system and/or by the user. At step 612, if the AI monitoring system (or the user) determines that the retrained correctness monitoring model outperforms the existing correctness monitoring model, the AI monitoring system replaces the existing model with the retrained model.

Although the example of FIG. 6A refers to a specific type of monitoring model, one of ordinary skill in the art will appreciate that some embodiments of the method 600 can be used to update any suitable type of monitoring model.

FIG. 6B shows an example of a method 650 for updating (e.g., adapting) a monitoring model of an AI monitoring system 300, according to some embodiments. At step 652, an AI system receives a query (e.g., user input). At step 654, an entity is extracted from the query. At step 656, a predictive model (e.g., monitoring model) generates a prediction related to the extracted entity. For example, if the entity extracted from the query is “mobile phone,” the predictive model may predict that the user wants to view information related to purchasing a mobile phone (rather than, for example, information related to repairing a mobile phone). At step 658, the generative AI system may construct a prompt based on the user's input, the extracted entity, and the model's prediction. At step 660, the generative model generates a completion responsive to the constructed prompt. At step 662, the user provides feedback indicating whether the generated completion is satisfactory. At step 664, the predictive model may be retrained based on the user's feedback, and the retrained model may be redeployed.

Although the example of FIG. 6B refers to a specific type of monitoring model, one of ordinary skill in the art will appreciate that some embodiments of the method 650 can be used to update any suitable type of monitoring model.

In some embodiments, an auditing facility 336 can analyze and/or track source data citations for the completions generated by the monitored AI system. In some embodiments, each vector embedding in the knowledge base 130 of the monitored AI system represents a chunk of source data. In some embodiments, the chunk of source data represented by a vector embedding can be identified and retrieved based on the vector embedding (e.g., by accessing a lookup table or a database indexed by the vector embeddings). In some embodiments, when a prompt 135 constructed by the monitored AI system includes context derived from one or more embeddings of the knowledge base, the prompt construction facility 120 can create prompt metadata (e.g., metadata including those embeddings and/or data identifying the chunks of source data corresponding to those embeddings) and associate the prompt metadata with the constructed prompt 135. In such embodiments, the generative model 140 of the monitored AI application or the auditing facility 336 of the AI monitoring system can use the prompt metadata to provide citations (to chunks of the source data) for the information in the content generated by generative model 140. In some embodiments, the auditing facility 336 can analyze (e.g., count), report (e.g., list), or track (e.g., store, log, etc.) the citations associated with the generated content. In some embodiments, the auditing facility 336 can use these citations to assess whether the prompt construction facility 120 is correctly retrieving information from the knowledge base, what information is being retrieved, and whether some portions of the source data are over-represented, under-represented or improperly represented in aggregate retrievals. Aggregate evaluation of these citations can in some examples be scored using n-gram importance or reported as a list of source data chunks (e.g., documents) used to augment the original prompt.

In some embodiments, a quantitative assessment facility includes a sentiment classifier that can classify prompts and/or generated content as positive or negative. In some examples, topicality is assessed using a NeMo guardrail model.

In addition to the monitoring capabilities described above, in some examples, an AI assessment facility can monitor the values of custom (e.g., user-defined) metrics, provide custom (e.g., user-defined) guardrails, and/or perform other monitoring tasks. In some examples, based on such metrics, guardrails, and/or tasks, the AI assessment facility can evaluate and/or moderate the content generated by the generative AI system.

FIG. 6C shows a block diagram of a generative AI system for generating responses to Requests for Proposal (RFPs), which illustrates an example of how monitoring models can be used to improve the functioning and utility of a generative AI system, according to some embodiments. In the example of FIG. 6C, the generative AI system is configured to generate a Response to a Request for Proposal (RFP), or to questions within an RFP. In this example, the AI system's knowledge base may include information extracted from existing RFP Responses prepared by an organization and/or internal documents of the organization that are likely to be relevant to the types of questions posed in RFPs (e.g., information related to the organization's products, information related to the organization's policies and compliance with legal requirements, information related to the organization's sales, etc.). A question from the RFP may be provided as a query to the AI system. The AI system may identify embeddings in the knowledge base that represent concepts that are similar to (e.g., related to) the question and retrieve those embeddings (or the source data corresponding to the embeddings), and the generative model (e.g., LLM) may generate a response to the query (e.g., a completion) based on those retrieved embeddings (or source text). A monitoring model (e.g., “triage model”) may assess the quality of the generated completion (e.g., by estimating the probability that the generated completion is satisfactory). If the triage model has low confidence in the quality of the generated completion, the AI monitoring system may provide a prediction explanation to help the user understand the manner in which the completion may be flawed. In some embodiments, the triage model may be trained via supervised learning. In some embodiments, the triage model may be automatically generated based on a human user's labeling of the AI system's generated completions as satisfactory or unsatisfactory. In this way, the AI system may handle the routine drudgery associated with preparing an RFP Response, so that human experts can focus on the more nuanced or difficult portions of the Response.

In some embodiments, reporting tools can use monitoring models and/or additional generative models to explain changes detected by the monitoring models. For example, when drift in the content (e.g., completions) generated by an AI system's generative model 140 is detected, the outputs of other monitoring models may indicate whether the completions drifted in response to drift in the user inputs, the constructed prompts, or the information provided by the knowledge base. In some embodiments, monitoring models may be used to generate embeddings for the AI system's completions and identify the topics associated with those embeddings. In some embodiments, monitoring models may assess the AI system's sensitivity to various words (e.g., in the user input) and alert the user when high-sensitivity words are used. In some embodiments, one or more generative models may be used to automatically generate text explaining the outputs of the monitoring models using natural language. Visualizations of the monitored metric values and/or the corresponding explanations can be provided to the user in real time (e.g., in a system monitoring dashboard). In some embodiments, the AI monitoring system may be configured with thresholds or ranges related to the metric values, and the AI monitoring system may alert the user when the value of a metric exceeds a corresponding threshold or departs from a specified range.

Some Embodiments of Techniques for Assessing and/or Explaining Word Impact

Using word impact metrics, a generative AI system can highlight or otherwise identify the specific tokens in a query that led a generative model to generate content related to a particular topic in response to the query, or led a prompt construction facility to retrieve embeddings from the knowledge base related to a particular topic in response to the query. Some embodiments of methods for assessing word impact are described herein.

Providing word impact assessments enables the user, an AI development system, or an AI monitoring system to adjust queries to improve the relevance of the matching information returned by the knowledge base. In addition, providing word impact assessments enables the generative AI system to label the topics represented by embeddings and documents in the knowledge base. Such topic labeling enables the generative AI system to generate visualizations of the knowledge base's embedding space, which can help users identify gaps (missing information) and/or junk (unwanted information) in the knowledge base (KB). New source data (e.g. documents) with the missing information can then be added to the KB, and the source data (and embeddings) representing the unwanted information can be removed from the KB, thereby producing an enhanced KB with a higher percentage of information relevant to the intended knowledge domain. Such topic labeling also facilitates the use of Auto ML techniques to automatically curate the knowledge base (e.g., by identifying clusters of embeddings related to unwanted concepts and removing those embeddings and the corresponding source data from the knowledge base).

Referring to FIG. 6D, an example of a visualization of a knowledge base's embedding space is provided, according to some embodiments. Such visualizations may be generated by mapping the vector embeddings into a two-dimensional space. In the example of FIG. 6D, the different clusters of vector embeddings are labeled with the topics to which those clusters pertain (e.g., “API Use Docs,” “Modeling Docs,” “Prediction Docs,” “CSS,” “HTML,” and “Vector Images”). In some embodiments, the topic assigned to a cluster of embeddings may be the concept associated with the centroid of the cluster. In some embodiments, the system may use cluster analysis or anomaly detection techniques to identify outlying clusters, and either automatically prune the embeddings in such clusters or notify the user of the clusters' presence (and topics) so the user can decide whether to remove the embeddings from the KB.

In some examples, word impact analysis (or “word importance” analysis) can improve the explainability of generative models (e.g., LLMs). In some embodiments, word impact is assessed by varying (e.g., masking) individual words (or phrases) in prompts to uncover their statistical impact on the outputs of a generative model. Unlike classical attention, word importance measures the impact of prompt words on arbitrarily-defined text scores, which enables decomposing the importance of words into the specific measures of interest, including bias, reading level, verbosity, etc. This procedure also enables measuring word impact when attention weights are not available.

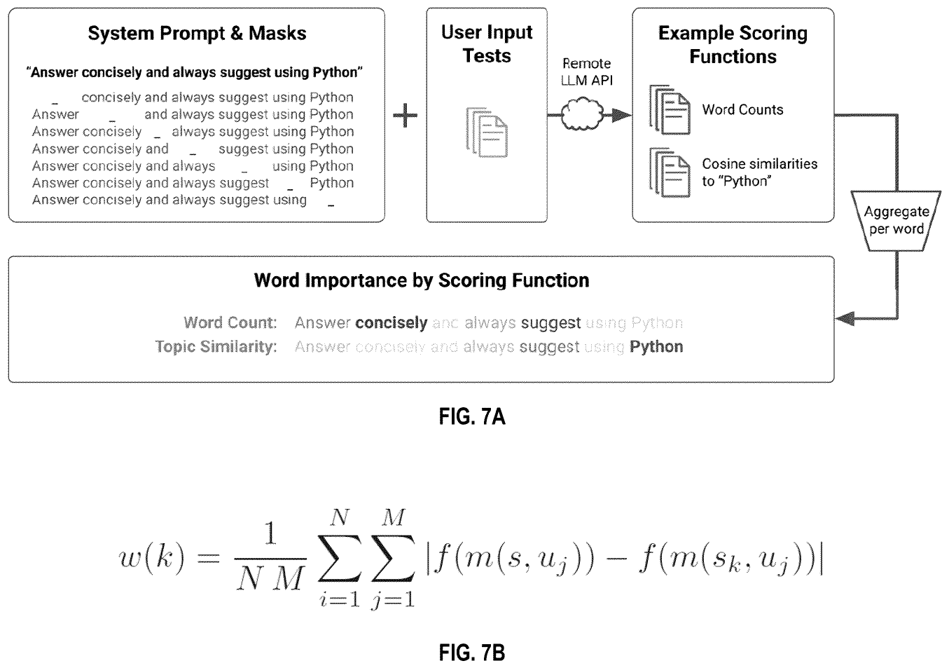

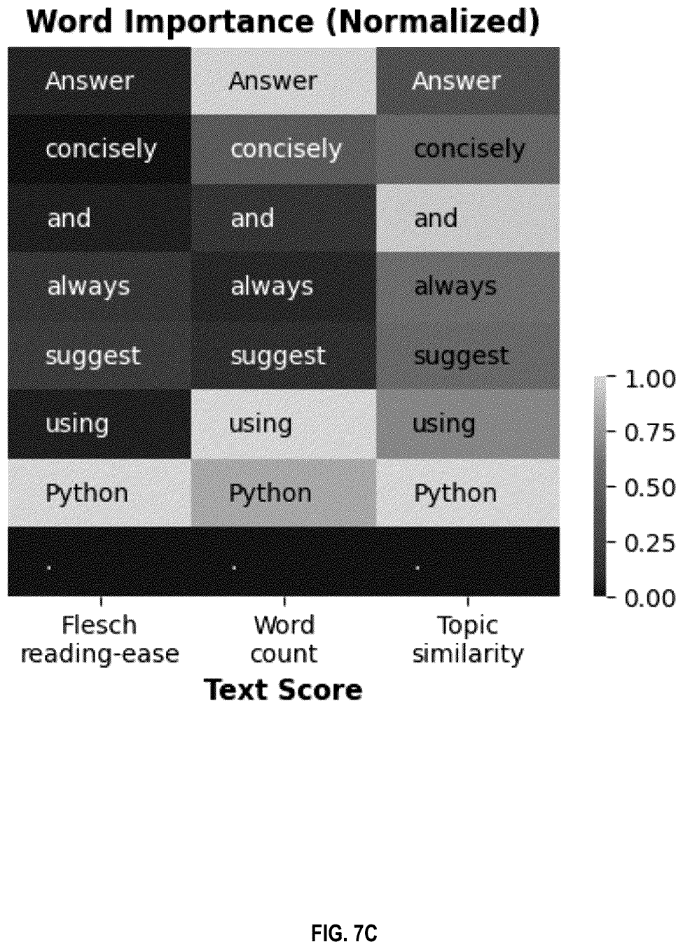

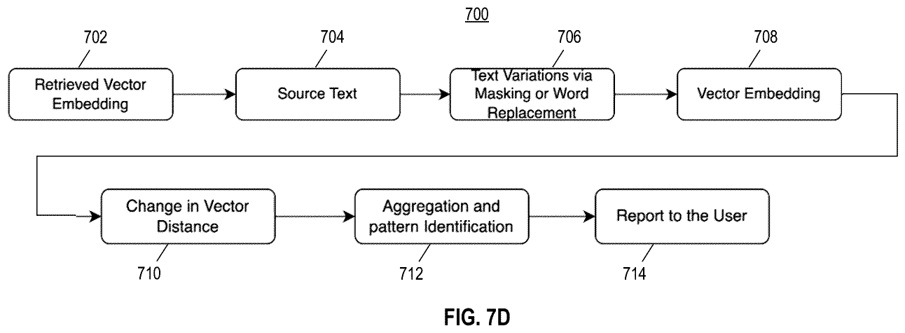

FIG. 7A illustrates a method for assessing word importance, according to some embodiments. In the method of FIG. 7A, words from a system prompt are masked with an underscore. The masked system prompts, together with user inputs, are passed to a generative model and the generative model's outputs are evaluated with arbitrary text scores. The importance score for every word from the prompt with regard to the selected text score is computed by comparing these results with the results from using the original system prompt.

In some embodiments, a method for assessing word importance can be summarized as follows. Given a system prompt s and a set of M user inputs U per system prompt, the word importance assessment method can involve systematically masking one word k at a time and observing the resulting changes in a user-defined NLP scoring function ƒ based on the model's output m(s, u) for u∈U.

In some embodiments, a word importance assessment method includes a step of sampling baseline output of the generative model using the unmodified system prompt and one or more example user prompts per system prompt. Next, one word k in the system prompt s is masked (e.g., by replacing the word with an underscore character), giving sk, and the generative model is sampled again with the modified system prompt, computing m(sk, u). Next, one or more user-defined metric scores ƒ are calculated for each output of the generative model. The relative importance w(k) of each masked word k is given by computing the absolute value of the difference between the masked-prompt score ƒ(m(sk, uj)) and the baseline score ƒ(m(s, uj)), e.g., using the equation shown in FIG. 7B, where N is the number of completions generated by the model. This methodology is text score agnostic—any scoring function for assessing the output text can be used to ascertain word importance.

As can be seen in FIG. 7A, the model first takes the original system prompt “Answer concisely and always suggest using Python”, combined with a user input and generates a baseline scoring response utilizing a scoring function. Then, in the first masking iteration, the word “Answer” in the system prompt is masked, and the model uses “_concisely and always suggest using Python”, combined with user inputs to generate new scoring responses. Comparing the scoring responses with the baseline can yield a better understanding of the importance of the words to the model and its output. This process is repeated for all the words in the system prompt. FIG. 7C shows an example of a visualization of the results of the word impact assessment.

In some embodiments, a word importance assessment method includes a baseline calculation step, a word masking and output generation step, and a scoring and impact calculation step. In the base calculation step, for every combination of system prompt s and user input u, the model's output m(s, u) is computed multiple N-times to establish baseline scores ƒ(m(s, u)). These baselines provide the reference against which changes are measured. In the word masking and output generation step, each word in the system prompt is sequentially masked, creating a modified version of the system prompt sk. With the word k masked, the model is tasked N-times with generating outputs. In the scoring and impact calculation step, for every generated output m(sk, u) from the masked input, a score |ƒ(m(s, u))−ƒ(m(sk, u))| is derived. This score represents the deviation from the baseline, obtained by computing the absolute value of the change in output score relative to the baseline. An average of these deviation scores across the N iterations provides an “impact score” w(k) for the blanked word k, reflecting its relative importance, according to the equation shown in FIG. 7B.

FIG. 7D illustrates an example of another method 700 for assessing word impact in a generative AI system, according to some embodiments. In step 702, a vector embedding is retrieved from a KB. The retrieved vector embedding may be, for example, a vector embedding associated with a particular topic or a vector embedding returned by the KB in response to a particular query. At step 704, the source data (e.g., a chunk of source data, a document, a portion of a document, etc.) represented by the retrieved vector embedding is obtained. At step 706, a variation of the text of the source data is generated by masking one or more words in the text (e.g., replacing the word(s) with a symbol, such as an underscore) and/or replacing one or more words in the text (e.g., with similar words or words related to similar topics). At step 708, a new vector embedding corresponding to the variation of the source text is generated. At step 710, the distance between the original vector embedding (retrieved at step 702) and the new vector embedding is calculated. This distance indicates the extent to which the variations introduced at step 706 change the apparent topic of the text (or change the relevance of the text to the topic associated with the original vector embedding). Alternatively, this distance indicates the extent to which the process of generating the KB's embeddings is sensitive to the variations introduced at step 706. Greater distances between the original vector embedding and the new vector embedding indicate that the KB's representation of the topic of the text is more sensitive to word(s) masked, replaced, or added at step 706. Shorter distances between the original vector embedding and the new vector embedding indicate that the KB's representation of the topic of the source text is less sensitive to the word(s) masked, replaced, or added at step 706.

Steps 706-710 may be repeated one or more times to generate measurements of the importance of various words to various topics. At step 712, these measurements are aggregated and pattern identification techniques are used to assess which words are more important or less important to various topics. At step 714, the word importance scores may be reported to the user.

An example has been described in which word importance is assessed with respect to topic analysis of the information in the KB. In some embodiments, word impact assessment method 700 may be used to assess the extent to which one or more words in a query (e.g., user input or constructed prompt) determine which matching embedding vector is returned by the KB. For example, at step 706, the text variations may be applied specifically to one or more words contained in the query. In this case, the word importance scores reported to the user indicate the importance of the words in the query to matching the information returned by the KB. In some embodiments, at step 714, the word importance scores may be reported to an Auto ML system, which may suggest modifications to the user input (or query) to match more relevant content.

In some embodiments, the word impact assessment method 700 may be used to assess the importance of words in a query in the following manner. At step 702, the vector embedding for the text of the query may be generated. At step 706, masking and/or word replacement experiments may be applied to the text of the query, thereby generating variations of the query. At step 708, vector embeddings for the variations of the query may be generated. At step 708, the distances between the original query's vector embedding and the vector embeddings of the query variants may be calculated. Based on aggregation and pattern analysis of those distances, the importance of the words to the query (or the sensitivity of the query to the words in the query) may be assessed, reported, and/or acted upon. For example, the query may be adapted to omit words that have matched information of low relevance, or embeddings of low relevance that matched words in the query may be pruned from the KB.

In some embodiments, a word impact facility may evaluate word importance for various words that appear in data objects (e.g., the queries contained in an evaluation dataset, prompts constructed based on the queries contained in an evaluation dataset, completions generated by a generative AI system in response to such queries or prompts, etc.). In some embodiments, a prompt assessment facility can use the results of such a word impact analysis to automatically reconfigure the prompt construction facility of the generative AI system to provide better prompts, and to guide a user to perform such reconfiguration.

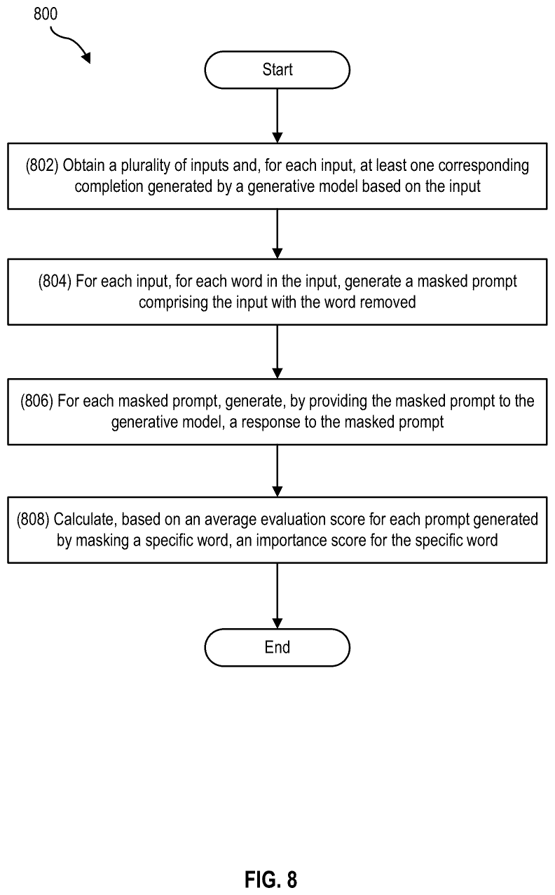

FIG. 8 is a flow diagram of an illustrative method 800 for evaluating word importance, according to some embodiments. At step 802 of method 800, a word impact facility may obtain a collection of queries (e.g., from an evaluation dataset) and, for each query in the evaluation dataset, at least one completion generated by a generative model in response to the query.

At step 804, for each word in each query in the evaluation dataset, the word impact facility may generate a masked prompt that includes the query with the word masked. In some examples, the word may be “masked” by removing the word or replacing the word with placeholder text. The placeholder text may indicate to a generative model that a word has been masked. In some embodiments, the placeholder text may include one or more underscores.

At step 806, the word impact facility may, for each masked prompt, generate a completion in response to the masked prompt by providing the masked prompt to the a generative AI system.

At step 808 of method 800, the word impact facility may calculate, based on average evaluation scores for each prompt generated by masking a specific word, an importance score for the specific word. In some embodiments, the model evaluation system may score each completion based on a Flesch reading-ease score, word count, and/or topic similarity. Word importance may be determined based on how much and in what direction such scores change when the word is masked.

As may be appreciated from the above description, the word importance assessment method 800 can generate word importance scores that are specific to the generative AI system used to generate completions in response to the masked prompts. The differences in word importance for different generative AI system can help users select generative AI systems that focus on appropriate words, and/or aid users in the development of prompt construction facilities tailored to specific generative models by revealing how specific words are likely to affect the completions provided by those models.

In some embodiments, a word impact facility (235, 335) can determine word impact scores for a data object (e.g., a query, user input, prompt, etc.) using any of the word impact assessment methods described herein, or any other suitable method for assessing word impact. In some embodiments, a word impact facility can use word impact scores to assess and/or explain the operation of portions of a generative AI system. In some examples, the word impact facility can use word impact scores to generate and provide similarity match explanations and/or completion explanations, as described herein. In some examples, the word impact facility (or a prompt assessment facility) can use word impact scores to assess the relationship between a query (e.g., user input or prompt), the context data retrieved from a knowledge base by a prompt construction facility based on the query, and/or the content of a completion generated by an AI system in response to the query, as described herein.

### Some Embodiments of Techniques for Assessing Prompts

A data scientist may improve the performance of a generative model or generative AI system (as assessed by metrics, including the metrics discussed herein) by constructing prompts for the generative model based on the user's input. In some cases, the prompts may be constructed in accordance with a prompt template. However, developing an effective prompt template or an effective approach to prompt construction can be challenging, because the exact wording of the prompt can be important, and the effectiveness of a prompt construction strategy may vary across different generative models and different user inputs. Additionally, obtaining representative user inputs can be complicated without understanding the domain, and understanding which specific parts of the user input impact the completion generated by the generative model in response to the constructed prompt can be challenging.

Prompt construction strategies are often applied in an ad hoc fashion, which can make it difficult to standardize such strategies or to inspire confidence in the model's performance beyond a subjective reporting proffered by the team members. Additionally, failures and successes are often tracked through third party tools and subsequently summarized into qualitative statements, and different generative models or generative AI systems generally are not compared on the same user inputs.

According to some embodiments, the aforementioned challenges are addressed by providing quantitative assessments of generative models/generative AI systems (or the content they generate), and by using those quantitative assessments to automatically improve prompt construction (or “input text construction”) approaches.

In some embodiments, an AI system assessment facility (230, 330) (e.g., a prompt assessment facility of an AI system assessment facility) manages a query repository containing queries (e.g., user inputs) against which the content (e.g., completions) generated by a generative model (or generative AI system) can be evaluated. These queries can be provided by the user, generated by the system based on source data (e.g., the source data represented in the knowledge base), and/or generated by the based on existing user inputs. The AI system assessment facility can further use assessment scores to help guide generation of additional queries or highlight priority queries for assessment. In some examples, the generation and management of the query repository addresses the need for standardized, relevant queries. By leveraging existing source data (e.g., documents), the AI system assessment facility can generate relevant queries even without the aid of a domain expert. The AI system assessment facility can then help generate queries or guide the user to create queries that avoid potential issues, such as toxic or biased answers.

A prompt construction approach can include i) providing a prompt template of text to guide the prompt construction facility, ii) constructing a prompt based on the query and on information (e.g., context) retrieved from the knowledge base, iii) comparing the content generated by the AI system's generative model in response to the constructed prompt to information returned by one or more other generative models (e.g., a different generative model or a fine-tuned variant of the AI system's generative model), and adapting the prompt based on the information returned by the other generative models. In some implementations, the system is able to propose new queries, prompts, and prompt templates, and/or to propose revisions to existing queries, prompts, and prompt templates based on assessment scores.

In some embodiments, the AI system assessment facility can apply one or more prompt construction approaches to one or more queries from the query repository to construct one or more prompts, provide the constructed prompts as inputs to the AI system's generative model to obtain a set of completions generated by the model in response to the prompts, provide quantitative assessments of the generated completions, and evaluate the prompt construction approaches based on those quantitative assessments.

In some embodiments, the AI system assessment facility maintains an historical archive of previous queries, prompt construction approaches, completions generated in response to the constructed prompts, and assessment scores. In some examples, the AI system assessment facility can evaluate a set of completions against a variety of assessment criteria. These assessment criteria may be based on the values of metrics, outputs from predictive monitoring models (e.g., predictive models configured to audit or monitor the generative AI system), or outputs from generative monitoring models (e.g., generative models configured to audit or monitor the generative AI system). The AI system assessment facility can then vary the words (or suggest variations of words) in the query, the constructed prompt, or the prompt template to determine the word impact of the individual words on each metric. In some embodiments, a quantitative record of how different approaches perform against the variety of criteria can be presented to the users in a rigorous way (e.g., “approach A has the potential to be more toxic but it is more faithful to the questions than approach B”).

In some embodiments, users can provide their own assessments of the completions generated by the generative AI system, and the AI system assessment facility can validate or retrain the monitoring models based on the users' assessments.

According to some embodiments, providing seamless integration between different assessment methods can facilitate development of models that provide quantitative scores based on subjective comparisons. Further, by leveraging these scores, the AI system assessment facility can recommend prompt construction approaches that address poor-performing scores and recommend models to the end-user that perform well in connection with such prompt construction approaches.

In contrast, existing approaches tend to rely on the user's education and expertise, and require the user to manually record and interpret the completions over time for the purposes of providing an expert comparison. In addition, current approaches tend to lack automated model building capabilities, and the ability to train and update a model during the assessment phase based on the user's feedback.

According to some embodiments, the methods and systems disclosed herein yield prompt construction approaches that perform better across metrics compared to existing automated prompt construction approaches or manual prompt construction by humans. For example, the techniques disclosed herein may yield improvement in the system's prompt construction approach(es). When the prompts produced using those improved approaches are applied to a generative model, the content generated by the model may be more relevant to the user's query (e.g., more on-topic), which in turn can yield higher user satisfaction scores (e.g., for a customer service hotline). In some embodiments, the methods and systems disclosed herein can reduce the user's exposure to legal or regulatory risk by suppressing completions with inappropriate content (e.g., toxic or biased content).

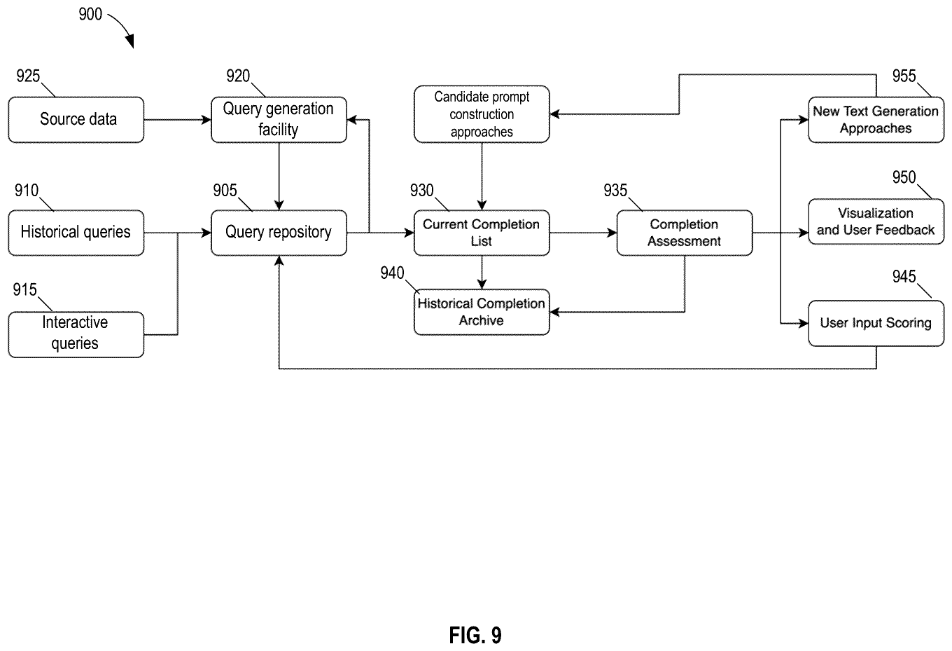

FIG. 9 is a block diagram depicting the use of an AI system assessment facility 900 to assess the prompts of a generative AI system, according to some embodiments. In some embodiments, AI system assessment facility 900 includes a query repository 905 configured to receive and store historical queries (e.g., user inputs) 910 and ongoing interactive queries 915. A query generation facility 920 may generate additional queries based on the queries in the repository, the knowledge base, and/or the source data 925 represented in the knowledge base. The generated queries may also be stored in the query repository 905.

In some implementations, the AI system's generative model generates a completion list 930 in response to queries or in response to prompts based on the queries. After the completion list 930 is generated, AI system assessment facility 900 may proceed to the assessment phase performed by completion assessment facility 935. The completion assessment facility 935 assesses the completions in the completion list 930. In some implementations, the AI system assessment facility 900 includes a historical completion archive 940 that stores responses previously generated by the generative model of the AI system and the assessments of those responses. Based on the completion assessments, AI system assessment facility 900 may produce one or more outputs (e.g., a query score 945, a visualization and user feedback 950, a recommendation regarding a new prompt construction approach 955, etc.). In some embodiments, the query score 945 may be based on one or more metrics such as, but not limited to, factual correctness, reading level, toxicity, etc. In some embodiments, the word impact of one or more words (e.g., every word) of the query is determined. By way of example and not limitation, recommendations regarding prompt construction approaches 955 can include recommendations regarding prompt templates, recommendations regarding a system prompt, etc.

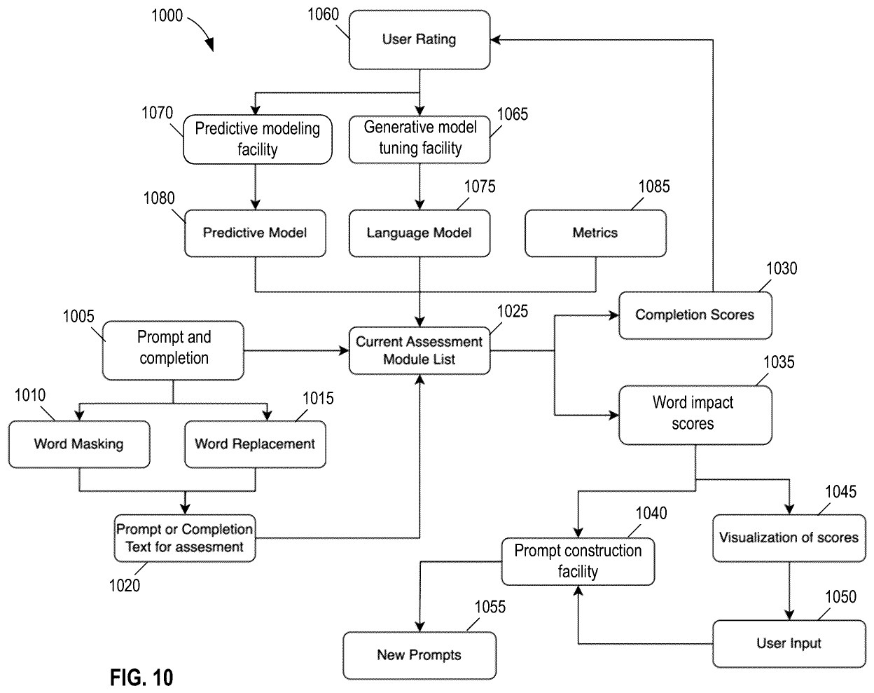

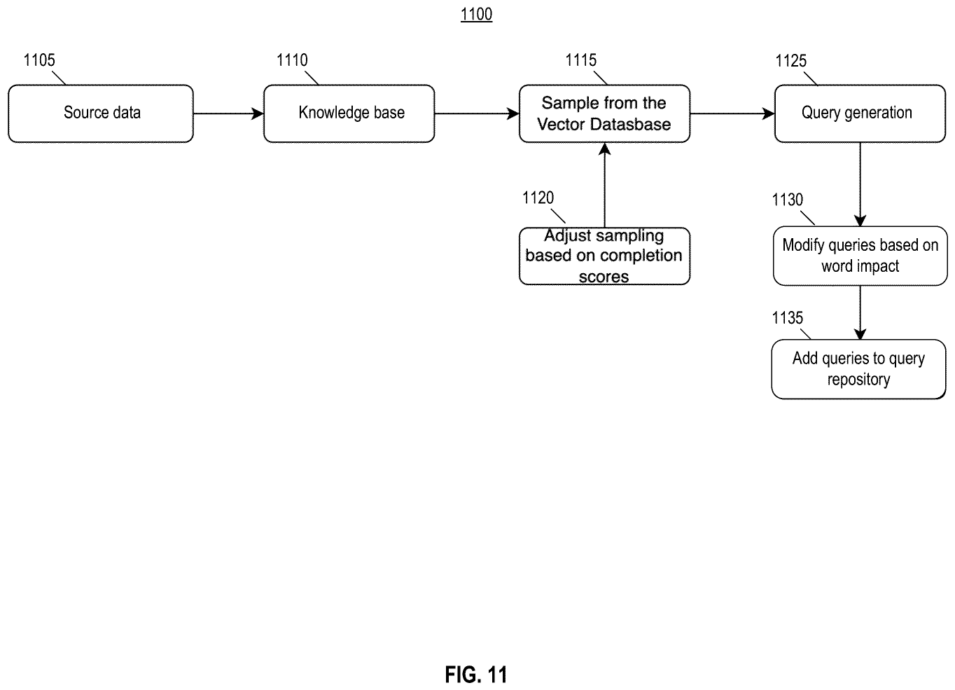

According to some embodiments, FIG. 10 is a flow diagram of completion assessment method 1000. In some embodiments, the completion assessment facility 935 of FIG. 9 performs the completion assessment method 1000. At step 1005, a prompt and the completion generated by the generative model of the AI system in response to that prompt are provided. The completion assessment facility 935 may apply word masking 1010 and/or word replacement 1015 to the prompt and/or to the completion, thereby producing a new prompt and/or new completion 1020 for assessment. Subsequently, the original and new prompts and completions are assessed 1025 using various criteria or metrics, and this assessment produces completion scores 1030 and word impact scores 1035 for the prompts and/or completions. One or more visualizations of the word impact scores 1035 may be provided to the user. Based on the visualizations (or other factors), the user may provide 1050 a new query, which may be supplied as input to the prompt construction facility 1040 to construct a new prompt 1055. In some embodiments, the word impact scores 1035 may be used to retrain the prompt construction facility 1040 to construct better prompts.

In some embodiments, the user may provide user ratings 1060 of the completions generated in response to one or more (e.g., all) of the prompts (1005, 1020, 1055). Based on the user rating(s) 1060, an AI development system or an AI monitoring system may use a generative model tuning facility 1065 to retrain or fine-tune the generative model 1075 of the AI system, and/or may use a predictive modeling facility 1070 to retrain one or more predictive monitoring models 1080. In some examples, the predictive modeling facility 1070 uses automated machine learning techniques to automatically retrain the predictive monitoring model(s). The completion assessment facility 935 may then use the tuned language model 1075 and/or retrained predictive monitoring model(s) 1080 to reassess 1025 the prompts and corresponding completions in the current assessment list.

FIG. 11 is a flow diagram of a query generation method 1100 performed by a query generation facility 920, according to some embodiments. The query generation facility 920 receives source data 1105 and generates a knowledge base (e.g., vector database) 1110, from which the query generation facility 920 samples vector embeddings at step 1115. According to some embodiments, sampling can be adjusted based on completion scores at step 1120. Sampling in this context refers to selecting candidate data for new query generation at step 1125. Subsequently, any new queries generated at step 1125 can be modified based on word importance at step 1130 and the modified query may be added to the query repository at step 1135.

### Some Further Embodiments of Techniques for Monitoring an AI System

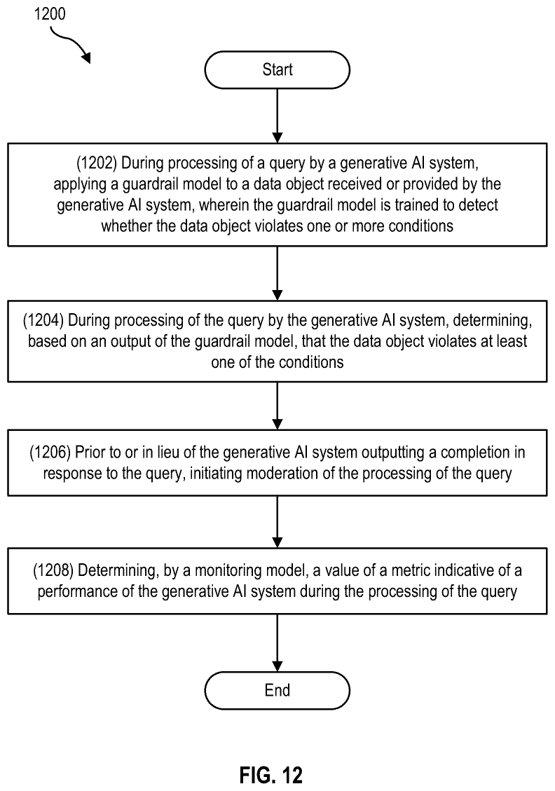

FIG. 12 is a flow diagram a method 1200 for monitoring an AI system, according to some embodiments. In some embodiments, the method 1200 includes steps 1202-1208. In some embodiments, one or more of the steps (e.g., steps 1202-1206, or step 1208) are omitted. The monitoring method 1200 may be performed, for example, by an AI assessment facility.

In step 1202, during processing of a query by a generative AI system, a guardrail model is applied to a data object received or provided by the generative AI system. The guardrail model may be trained to detect whether the data object violates one or more conditions.

In step 1204, during processing of the query by the generative AI system, the AI assessment facility determines, based on an output of the guardrail model, that the data object violates at least one of the conditions.

In step 1206, prior to or in lieu of the generative AI system outputting a completion in response to the query, moderation of the processing of the query is initiated.

In step 1208, the AI assessment facility determines, with a monitoring model, a value of a metric indicative of a performance of the generative AI system during the processing of the query.

### Computer-Based Implementations

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application.

Some exemplary functional facilities have been described herein for carrying out one or more tasks. It should be appreciated, though, that the functional facilities and division of tasks described is merely illustrative of the type of functional facilities that may implement the exemplary techniques described herein, and that embodiments are not limited to being implemented in any specific number, division, or type of functional facilities. In some implementations, all functionality may be implemented in a single functional facility. It should also be appreciated that, in some implementations, some of the functional facilities described herein may be implemented together with or separately from others (i.e., as a single unit or separate units), or some of these functional facilities may not be implemented.

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner, including as computer-readable storage media of a computing device 1300) or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

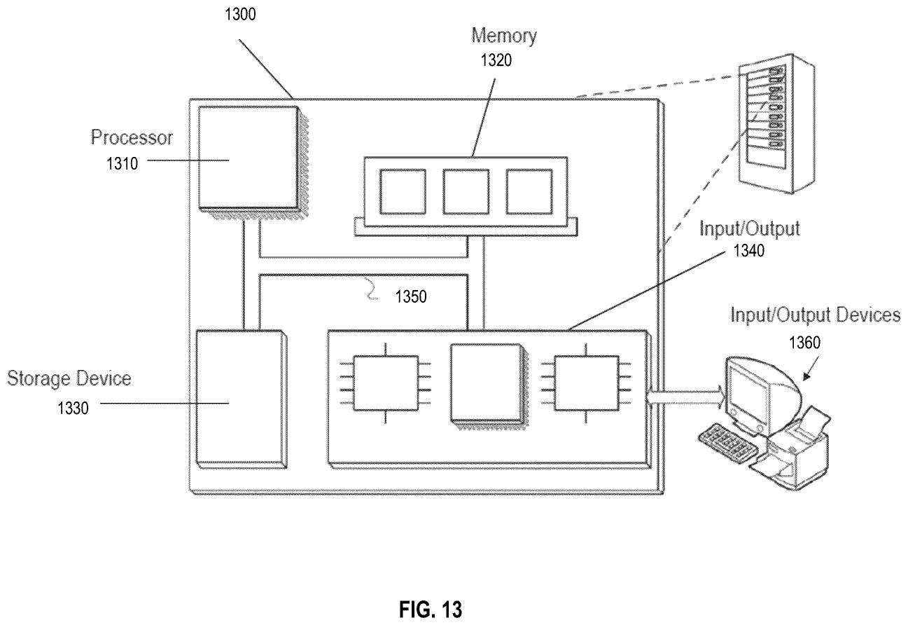

In some, but not all, implementations in which the techniques may be embodied as computer-executable instructions, these instructions may be executed on one or more suitable computing device(s) operating in any suitable computer system, including the exemplary computer system of FIG. 13, or one or more computing devices (or one or more processors of one or more computing devices) may be programmed to execute the computer-executable instructions. A computing device or processor may be programmed to execute instructions when the instructions are stored in a manner accessible to the computing device/processor, such as in a local memory (e.g., an on-chip cache or instruction register, a computer-readable storage medium accessible via a bus, a computer-readable storage medium accessible via one or more networks and accessible by the device/processor, etc.). Functional facilities that comprise these computer-executable instructions may be integrated with and direct the operation of a single multi-purpose programmable digital computer apparatus, a coordinated system of two or more multi-purpose computer apparatuses sharing processing power and jointly carrying out the techniques described herein, a single computer apparatus or coordinated system of computer apparatuses (co-located or geographically distributed) dedicated to executing the techniques described herein, one or more Field-Programmable Gate Arrays (FPGAs) for carrying out the techniques described herein, or any other suitable system.

FIG. 13 is a block diagram of an example computer system 1300 that may be used in implementing the technology described in this disclosure. General-purpose computers, network appliances, mobile devices, or other electronic systems may also include at least portions of the system 1300. The system 1300 includes a processor 1310, a memory 1320, a storage device 1330, and an input/output device 1340. Each of the components 1310, 1320, 1330, and 1340 may be interconnected, for example, using a system bus 1350. The processor 1310 is capable of processing instructions for execution within the system 1300. In some implementations, the processor 1310 is a single-threaded processor. In some implementations, the processor 1310 is a multi-threaded processor. The processor 1310 is capable of processing instructions stored in the memory 1320 or on the storage device 1330.

The memory 1320 stores information within the system 1300. In some implementations, the memory 1320 is a non-transitory computer-readable medium. In some implementations, the memory 1320 is a volatile memory unit. In some implementations, the memory 1320 is a non-volatile memory unit.

The storage device 1330 is capable of providing mass storage for the system 1300. In some implementations, the storage device 1330 is a non-transitory computer-readable medium. In various different implementations, the storage device 1330 may include, for example, a hard disk device, an optical disk device, a solid-date drive, a flash drive, or some other large capacity storage device. For example, the storage device may store long-term data (e.g., database data, file system data, etc.). The input/output device 1340 provides input/output operations for the system 1300. In some implementations, the input/output device 1340 may include one or more of a network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 1360. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 1330 may be implemented in a distributed way over a network, for example as a server farm or a set of widely distributed servers, or may be implemented in a single computing device.

Although an example processing system has been described in FIG. 13, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a system, program, software, a software application, an engine, a pipeline, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

Measurements, sizes, amounts, etc. may be presented herein in a range format. The description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as 10-20 inches should be considered to have specifically disclosed subranges such as 10-11 inches, 10-12 inches, 10-13 inches, 10-14 inches, 11-12 inches, 11-13 inches, etc.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

1. A generative AI system development method, the method comprising:
constructing, by one or more processors, a plurality of generative AI systems, wherein constructing the plurality of generative AI systems includes executing at least one modeling blueprint;
providing, by the one or more processors, a plurality of queries to each generative AI system in the plurality of generative AI systems, the plurality of queries being part of an evaluation dataset;
during processing of the plurality of queries by each generative AI system, monitoring values of one or more quantitative metrics;
providing, by the one or more processors for display by a user device, data indicating the values of the one or more quantitative metrics for each generative AI system; and
providing, by the one or more processors for display by the user device, a recommendation regarding use or non-use of at least one generative AI system included in the plurality of generative AI systems.

2. The method of claim 1, wherein each generative AI system in the plurality of generative AI systems is configured to operate as a chat bot, a natural language interface to a knowledge base, or content generation engine.

3. The method of claim 1, wherein each generative AI system in the plurality of generative AI systems is a retrieval-augmented generation (RAG)-based generative AI system.

4. The method of claim 3, wherein each generative AI system in the plurality of generative AI systems includes a knowledge base, a prompt construction facility, and a generative model.

5. The method of claim 4, wherein the constructing of each generative AI system in the plurality of generative AI systems is performed based on a set of values of a set of hyperparameters, and wherein the respective set of hyperparameter values corresponding to each generative AI system determines one or more attributes of the knowledge base, the prompt construction facility, or the generative model included in the generative AI system.

6. The method of claim 5, wherein the one or more attributes of the knowledge base include a type of encoder used to create a plurality of embeddings of the knowledge base, the plurality of embeddings representing a plurality of portions of source data.

7. The method of claim 5, wherein the one or more attributes of the prompt construction facility include (i) a process by which the prompt construction facility identifies one or more embeddings in the knowledge base matching an embedding representing a query, (ii) a process by which source data corresponding to the identified one or more embeddings is added to a constructed prompt, and/or (iii) a configuration of a prompt template used to construct the constructed prompt.

8. The method of claim 5, wherein the one or more attributes of the generative model include a type of the generative model.

9. The method of claim 4, wherein the plurality of generative AI systems include a first generative AI system, and wherein the method further comprises:
providing, by the one or more processors for display by a user device, a visual representation of an embedding space of the knowledge base of the first generative AI system.

10. The method of claim 9, wherein the visual representation of the embedding space includes a plurality of topic labels indicating the topics of a respective plurality of clusters of embeddings.

11-15. (canceled)

16. The method of claim 1, wherein the evaluation dataset is a synthetic evaluation dataset.

17. The method of claim 16, further comprising constructing the synthetic evaluation dataset.

18. The method of claim 1, wherein, for each generative AI system in the plurality of generative AI systems, the one or more quantitative metrics include:
a factual accuracy metric indicating an extent to which completions generated by the respective generative AI system in response to the plurality of queries are factual;
a faithfulness metric indicating an extent to which the completions generated by the respective generative AI system include hallucinated information;
a grounded-ness metric indicating an extent to which the completions generated by the respective generative AI system are based on context data extracted from the knowledge base of the respective generative AI system;
a toxicity metric indicating an extent to which the completions generated by the respective generative AI system include toxic content;
a latency metric indicating a latency associated with the processing of the queries and/or generation of the completions by the respective generative AI system;
a token count metric derived from a number of tokens included in the completions generated by the respective generative AI system; and/or
a cost metric indicative a cost incurred by using the generative model of the respective generative AI system to generate the completions.

19-20. (canceled)

21. A method comprising:
obtaining, by one or more processors, one or more first completions generated by a generative AI system in response to a query;
determining, by the one or more processors, a first value of a scoring metric for the query based on the one or more first completions;
for each word of a plurality of words in the query,
constructing, by the one or more processors, a masked query based on the query, wherein the respective word is masked or removed;
obtaining, by the one or more processors, one or more second completions generated by the generative AI system in response to the respective masked query;
determining, by the one or more processors, a second value of the scoring metric for the respective masked query based on the one or more second completions; and
determining, by the one or more processors, a word impact score of the respective word based on a difference between (i) the second value of the scoring metric for the masked query in which the word is masked or removed, and (ii) the first value of the scoring metric for the query; and
based on the word impact scores of the plurality of words, providing guidance relating to the query for display by a user device.

22-26. (canceled)

27. A method comprising:
selecting, by one or more processors, a plurality of clusters of embeddings from an embedding space of a knowledge base;
for each cluster of embeddings in the plurality of clusters of embeddings,
selecting, by the one or more processors, one or more embeddings from the respective cluster of embeddings;
obtaining a respective portion of source data represented by the selected one or more embeddings;
constructing, by the one or more processors, a prompt based on the obtained portion of source data, wherein the prompt relates to generating a question about the portion of source data and an answer to the question;
providing the prompt as input to a generative model; and
adding, by the one or more processors, the question and the answer generated by the generative model in response to the prompt to a synthetic evaluation dataset, wherein the prompt and the completion are included in a respective validation pair;
providing, by the one or more processors, a first prompt to a generative AI system, the first prompt including a first question of a first validation pair of the synthetic evaluation dataset;
comparing, by the one or more processors, a completion generated by the generative AI system in response to the first question and a first answer included in the first validation pair;
providing, by the one or more processors, an assessment of the generative AI system based on a result of the comparing.

28-33. (canceled)

34. A method comprising:
during processing of a query by a generative AI system,
applying a guardrail model to a data object received or provided by the generative AI system, wherein the guardrail model is trained to detect violation of one or more conditions;
determining, based on an output of the guardrail model, that the data object violates at least one of the conditions; and
prior to or in lieu of the generative AI system outputting a completion in response to the query, initiating moderation of the processing of the query.

35-36. (canceled)

37. The method of claim 34, wherein initiating moderation of the processing of the query comprises preventing the outputting of the completion by the generative AI system, providing an alert indicating that the data object violates the at least one of the conditions, and/or providing a recommendation regarding revising the query to avoid violating the at least one of the conditions.

38-39. (canceled)

40. The method of claim 34, wherein the one or more conditions include a prohibition on inclusion of personally identifiable information (PII) in the data object, a prohibition on toxic content in the data object, a prohibition on use of prompt injection techniques, a prohibition on a topic of the data object, and/or a prohibition on a sentiment of the data object.

41-44. (canceled)

45. The method of claim 34, wherein the data object comprises the query, content retrieved from a knowledge base, context data added to a constructed prompt, the constructed prompt, or the completion.

46. The method of claim 34, further comprising:
determining, by a monitoring model, a value of a metric indicative of a performance of the generative AI system during the processing of the query.

47-51. (canceled)
